(19) United States
(12) Patent Application Publication
(10) Pub. No.: US 2020/0342435 A1
(43) Pub. Date: Oct. 29, 2020

(54) COMMODITY SALES DATA PROCESSING SYSTEM, SETTLEMENT DEVICE, AND CONTROL METHOD THEREOF

(71) Applicant: TOSHIBA TEC KABUSHIKI KAISHA, Tokyo (JP)

(72) Inventor: Yukiyoshi YAMAZAKI, Gotemba Shizuoka (JP)

(73) Assignee: TOSHIBA TEC KABUSHIKI KAISHA, Tokyo (JP)

(21) Appl. No.: 16/723,219

(22) Filed: Dec. 20, 2019

(30) Foreign Application Priority Data
Apr. 23, 2019 (JP) 2019-081992

(51) Int. Cl. G06Q 20/20; G06Q 30/04; G06Q 50/12

(52) U.S. Cl. CPC G06Q 20/207; G06Q 20/209; G06Q 50/12; G06Q 30/04

(57) ABSTRACT

A computer of a settlement device acquires commodity data related to commodities registered by a registration device. The computer receives a selection of a first commodity from among the commodities. In response to receiving the selection of the first commodity, the computer changes a tax amount of a tax imposed on the first commodity from a first tax amount calculated at a first tax rate before the change to a second tax amount calculated at a second tax rate after the change. The computer settles a transaction based on the total cost of the first commodity, the total cost of the first commodity including the second tax amount.

### CROSS-REFERENCE TO RELATED APPLICATION

This application is based upon and claims the benefit of priority from Japanese Patent Application No. 2019-081992, filed on Apr. 23, 2019, the entire contents of which are incorporated herein by reference.

### FIELD

Embodiments described herein relate generally to a commodity sales data processing system, a settlement device used in the system, and a control method of the settlement device.

### BACKGROUND

Regarding a tax system in which a tax is imposed on the consumption of a commodity, there is a so-called reduced tax rate system in which a tax rate of a commodity directly related to daily life, such as food or beverage, is kept lower than that of other commodities. In the reduced tax rate system, the tax rate for the commodity subject to a reduced tax rate is lower than a normal tax rate for the commodity not subject to the reduced tax rate. However, even the commodity that is subject to the reduced tax rate may not be subject to the reduced tax rate depending on the form of consumption. For example, when the commodity subject to the reduced tax rate is defined as “beverages or foods excluding dining-out”, in a case of a so-called take-out that takes out the beverages or foods purchased at a store, the beverages or foods purchased at the store are subject to the reduced tax rate. However, if the beverage or food is eaten in the store, so-called in-store eating and drinking or eating-in, the beverages or foods are treated as dining-out, and thus the beverages or foods are not subject to the reduced tax rate.

It is a matter for the consumer to decide whether to take out or eat and drink the purchased beverages or foods in the store. For that reason, when a consumer who purchases foods or the like subject to the reduced tax rate offers the in-store eating and drinking, a store clerk of the store where the in-store eating and drinking is possible needs to operate a terminal of a commodity sales data processing system, a so-called point of sales (POS) terminal, so that sales data of the commodity is processed at the normal tax rate instead of the reduced tax rate.

In recent years, as the commodity sales data processing system for mass retailers, a semi-self-service type commodity sales data processing system is known in which a registration device and a settlement device are separated, the registration device is operated by a store clerk, and the settlement device is operated by a customer himself/herself. In this type of commodity sales data processing system, for example, it is difficult to change the tax rate in order for foods or the like registered as the take-out in the registration device to be set as the in-store eating and drinking at a settlement stage of the settlement device.

### DESCRIPTION OF THE DRAWINGS

FIG. 1 is a schematic diagram of a commodity sales data processing system according to an embodiment;

FIG. 2 is a schematic diagram illustrating a data structure of a commodity record stored in a commodity master file;

FIG. 3 is a block diagram illustrating a main circuit configuration of a registration device that constitutes the commodity sales data processing system;

FIG. 4 is a schematic diagram illustrating main work areas formed in a main memory of the registration device;

FIG. 5 is a schematic diagram illustrating a main data structure of commodity sales data;

FIG. 6 is a block diagram illustrating a main circuit configuration of a settlement device that constitutes the commodity sales data processing system;

FIG. 7 is a schematic diagram illustrating main work areas formed in a main memory of the settlement device;

FIG. 8 is a flowchart illustrating a main procedure of a scanning process executed by a processor of the registration device;

FIG. 9 is a flowchart illustrating a main procedure of an external tax process illustrated in

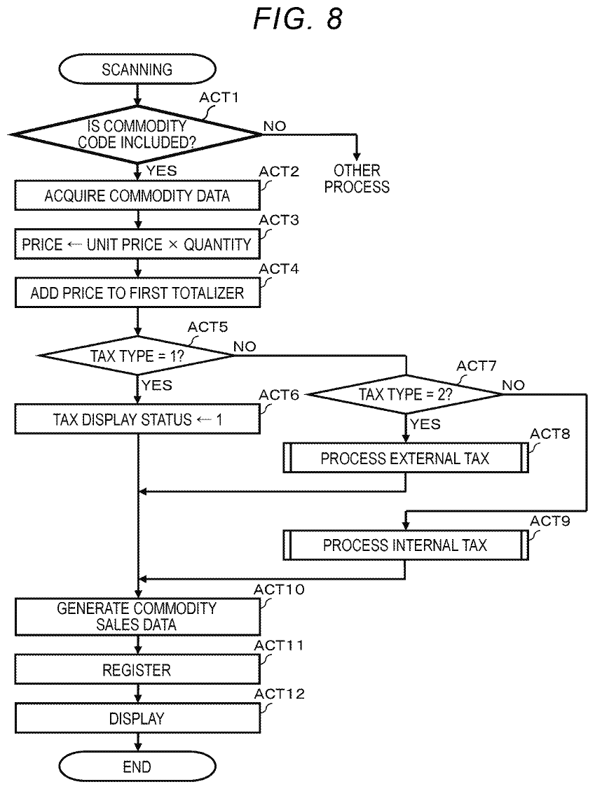

FIG. 8;

FIG. 10 is a flowchart illustrating a main procedure of an internal tax process illustrated in FIG. 8;

FIG. 11 is a flowchart illustrating a procedure of a main process executed by a processor of the settlement device;

FIG. 12 is a flowchart illustrating a main procedure of a tax rate change process illustrated in FIG. 11;

FIG. 13 is a flowchart illustrating a specific procedure of an external tax rate change process illustrated in FIG. 12;

FIG. 14 is a flowchart illustrating another specific procedure;

FIG. 15 is a flowchart illustrating another specific procedure;

FIG. 16 is a flowchart illustrating a specific procedure of an internal tax rate change process illustrated in FIG. 12;

FIG. 17 is another flowchart illustrating the specific procedure;

FIG. 18 is another flowchart illustrating the specific procedure;

FIG. 19 is a schematic diagram illustrating an example of a payment method selection screen displayed on a touch panel of the settlement device;

FIG. 20 is a schematic diagram illustrating an example of a registration details list screen displayed on the touch panel of the settlement device;

FIG. 21 is a schematic diagram illustrating an example of a first confirmation screen displayed on the touch panel of the settlement device;

FIG. 22 is a schematic diagram illustrating an example of a second confirmation screen;

FIG. 23 is a schematic diagram illustrating another example of the registration details list screen;

FIG. 24 is a schematic diagram illustrating another example of the first confirmation screen;

FIG. 25 is a schematic diagram illustrating another example of the second confirmation screen;

FIG. 26 is a schematic diagram illustrating another example of the registration details list screen; and

FIG. 27 is a schematic diagram illustrating an example of a printed receipt issued from the settlement device.

### DETAILED DESCRIPTION

Embodiments provide a settlement device that can cope with a tax rate change by a simple operation even when a tax rate of a tax imposed on a commodity changes depending on the form of consumption, and a commodity sales data processing system including the settlement device.

In general, according to one embodiment, a settlement device that is connected to a registration device via a network and performs settlement for commodities registered by the registration device includes acquisition means, receiving means, tax amount changing means, and settlement means. The acquisition means acquires data of the commodities registered by the registration device. The receiving means receives a selection of a commodity whose tax rate is to be changed from among the commodities. The tax amount changing means changes a tax amount of a tax imposed on the commodity for which the selection is received by the receiving means from a first tax amount calculated at a first tax rate before the change to a second tax amount calculated at a second tax rate after the change. The settlement means settles a transaction based on the total amount of the commodities including the second tax amount when the selection of the commodity whose tax rate is to be changed is received by the receiving means.

Hereinafter, an embodiment will be described with reference to the drawings. In this embodiment, a semi-self-service type commodity sales data processing system including a registration device and a settlement device is exemplified. Specifically, the semi-self-service type commodity sales data processing system is an example of a commodity sales data processing system in which even when a tax rate of a tax imposed on a commodity changes depending on the form of consumption, the tax rate change can be dealt with by a simple operation in the settlement device.

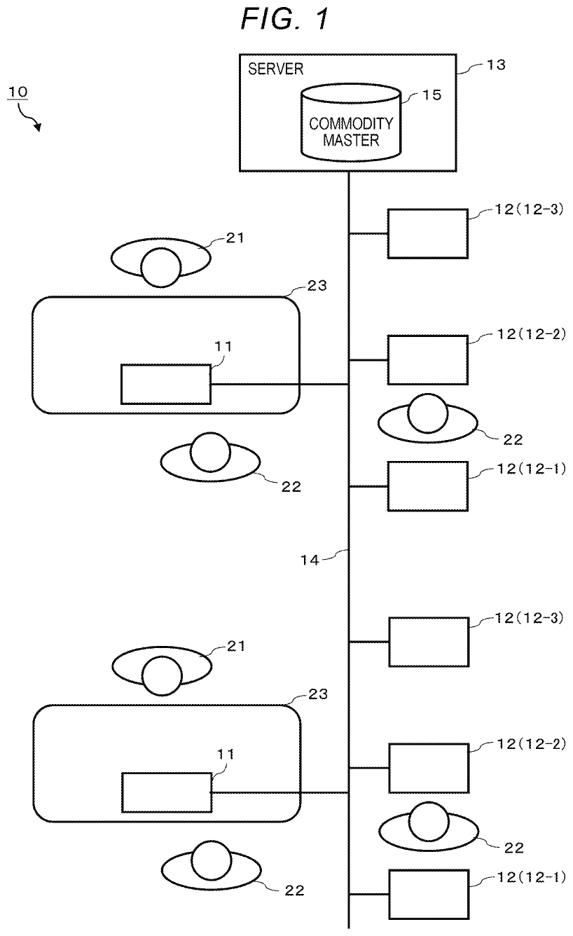

FIG. 1 is a schematic diagram of a commodity sales data processing system 10 according to this embodiment. The commodity sales data processing system 10 includes a plurality of registration devices 11, a plurality of settlement devices 12, a server 13, and a network 14 connecting the above components. The network 14 is typically a local area network (LAN). The registration device 11 and the settlement device 12 exchange information through the server 13. The registration device 11 and the settlement device 12 may exchange information without going through the server 13. The registration device 11 and another registration device 11 or the settlement device 12 and another settlement device 12 can exchange information through the server 13 or without going through the server 13, respectively. As the network 14, another communication network such as the Internet or a wireless LAN may be used instead of the LAN.

The registration device 11 and the settlement device 12 are disposed for each checkout lane of a store. In FIG. 1, a case where two registration devices 11 and six settlement devices 12 are disposed in two checkout lanes is illustrated. Specifically, an example in which one registration device 11 and three settlement devices 12 (12-1, 12-2, and 12-3) are disposed for one checkout lane is illustrated. The number of the registration devices 11 and the settlement devices 12 included in the commodity sales data processing system 10 is arbitrary. A ratio of the number of registration devices 11 and settlement devices 12 disposed in the checkout lane is also arbitrary.

In the registration device 11, a store clerk 21 who has a role as a checker is an operator thereof. In the settlement device 12, a customer 22 who purchases a commodity sold at the store is the operator of the settlement device 12. That is, the commodity sales data processing system 10 is a semi-self-service type system. Such a commodity sales data processing system 10 is also referred to as a semi-self-service type checkout system.

The registration device 11 is attached to a work table 23 in FIG. 1. The work table 23 has a rectangular top plate. By disposing a plurality of work tables 23 so that longitudinal directions of the top plates are substantially parallel, a passage for the customer 22, a so-called checkout lane, is formed.

The registration device 11 has functions of registering a sales commodity, generating checkout data (e.g., accounting data), and transmitting the checkout data to the settlement device 12. The registration device 11 functions as a sales commodity unit such that that a commodity purchased by the customer 22 is registered in the registration device 11 as a sales commodity. For example, by reading a barcode attached to a commodity with a scanner, the commodity is registered in the registration device 11 as a sales commodity. The checkout data is data relating to checkout of the sales commodity registered as one transaction, and is used for a settlement process described later.

The settlement device 12 has functions of receiving checkout data, transferring checkout data to another settlement device 12, and a settlement process. The settlement process is a process for settlement of a transaction that is an action for buying and selling commodities based on the checkout data. For payment, cash, a credit card, electronic money, and the like are used as payment methods. When the settlement device 12 receives checkout data from the registration device 11 or another settlement device 12, the settlement device 12 processes the transaction settlement based on the checkout data.

For settlement, a cash voucher such as a gift certificate may be used as a payment method of the price. When paying with a cash voucher, the store clerk needs to confirm the cash voucher. For that reason, the registration device 11 also has a settlement process function, and can mainly process settlement by a cash voucher. The registration device 11 alone can process settlement by cash, a credit card, electronic money or the like.

The server 13 includes a commodity master file 15. The commodity master file 15 may be formed in a storage device built in the server 13 or may be formed in an external storage device connected to the server 13.

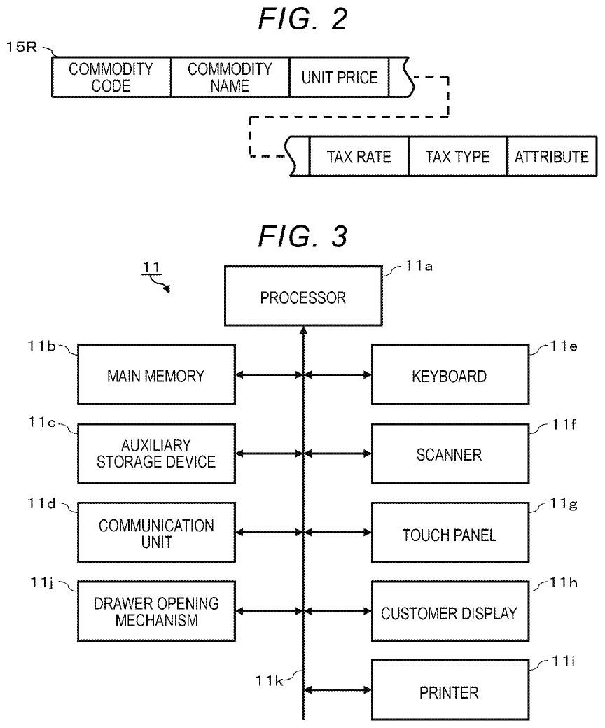

The commodity master file 15 stores a commodity record 15R (see FIG. 2). The commodity record 15R is generated for each commodity. The main data structure of the commodity record 15R is illustrated in the schematic diagram of FIG. 2. As illustrated in FIG. 2, the commodity record 15R includes data items such as a commodity code, a commodity name, a unit price, a tax rate, a tax type, and an attribute.

The commodity code is a unique code set for each commodity in order to identify each commodity. Usually, a barcode symbol obtained by converting the commodity code into a barcode or a two-dimensional data code symbol obtained by converting the commodity code into a two-dimensional data code is attached to each commodity. Alternatively, a radio frequency identification (RFID) tag storing a commodity code may be attached thereto. The registration device 11 can register commodity sales data by reading data of the barcode symbol, the two-dimensional data code symbol, or the RFID tag with a reader.

The commodity name and unit price are the name of the commodity identified by the commodity code and the price per unit. Hereinafter, the commodity identified by the commodity code is referred to as a corresponding commodity. The tax rate is a tax rate of a tax imposed on the consumption of the corresponding commodity. When the corresponding commodity is not a commodity subject to a reduced tax rate system, which is a so-called reduced tax rate commodity, the tax rate for the commodity is usually 10%. When the commodity is the reduced tax rate commodity, the tax rate for the commodity is 8%. As such, in this embodiment, the commodity record 15R is generated on the assumption of take-out for beverages or foods that are reduced tax rate commodities.

The tax type is information for identifying whether a tax for the commodity is an internal tax of which an amount of tax is included in the price, an external tax of which the amount of tax is not included in the price, or tax-exempt where no tax is imposed (i.e., there is no tax amount). In the embodiment, the tax type of internal tax is “3”, the tax type of external tax is “2”, and the tax type of tax-exempt is “1”. In a case of a commodity whose tax type is the external tax or tax-exempt, the unit price is a base price. In a case of a commodity whose tax type is the internal tax, the unit price is a tax-included price obtained by adding a tax amount for the tax rate to the base price. That is, the unit price of the commodity whose tax type is internal tax and whose tax rate is the normal tax rate is a price including a tax of 10%. The unit price of the commodity whose tax type is the internal tax and whose tax rate is a reduced tax rate is a price including a tax of 8%.

The attribute is information for identifying whether or not the commodity is subject to the reduced tax rate system. In the case of the embodiment, beverages or foods excluding dining-out are subject to the reduced tax rate system. For that reason, the attribute of beverages or foods is information indicating that the commodity is subject to the reduced tax rate system. The attribute of the other commodities is information indicating that the commodities are not subject to the reduced tax rate system.

FIG. 3 is a block diagram illustrating a main circuit configuration of the registration device 11. The registration device 11 includes a processor 11a, a main memory 11b, an auxiliary storage device 11c, a communication unit 11d, a keyboard 11e, a scanner 11f, a touch panel 11g, a customer display 11h, a printer 11i, a drawer opening mechanism 11j, and a system transmission path 11k. The system transmission line 11k includes an address bus, a data bus, a control signal line, and the like. The system transmission path 11k connects the processor 11a, the main memory 11b, the auxiliary storage device 11c, the communication unit 11d, the keyboard 11e, the scanner 11f, the touch panel 11g, the customer display 11h, the printer 11i, and the drawer opening mechanism 11j to each other. A computer of the registration device 11 is configured by connecting the processor 11a, the main memory 11b, and the auxiliary storage device 11c through the system transmission path 11k.

The processor 11a corresponds to a central part of the computer. The processor 11a controls each unit to implement various functions as the registration device 11 according to an operating system or an application program. The processor 11a is, for example, a central processing unit (CPU).

The main memory 11b corresponds to a main storage portion of the computer. The main memory 11b includes a nonvolatile memory area (e.g., a memory section) and a volatile memory area. The main memory 11b stores an operating system or an application program in the nonvolatile memory area. The main memory 11b may store data necessary for the processor 11a to execute processing for controlling each unit in the nonvolatile or volatile memory area. The main memory 11b uses the volatile memory area as a work area in which data is appropriately rewritten by the processor 11a. The nonvolatile memory area is, for example, a read only memory (ROM). The volatile memory area is, for example, a random access memory (RAM).

The auxiliary storage device 11c corresponds to an auxiliary storage portion of the computer. For example, an electric erasable programmable read-only memory (EEPROM), a hard disc drive (HDD), a solid state drive (SSD), or the like can be the auxiliary storage device 11c. The auxiliary storage device 11c stores data used when the processor 11a performs various processes, data generated by the processes in the processor 11a, and the like. The auxiliary storage device 11c may store the application program described above.

The application program stored in the main memory 11b or the auxiliary storage device 11c includes a control program described regarding information processing executed by the registration device 11, that is, a so-called registration program. A method for installing the registration program in the main memory 11b or the auxiliary storage device 11c is not particularly limited. The registration program can be recorded on a removable recording medium, or distributed by communication via a network 14 to be installed in the main memory 11b or the auxiliary storage device 11c. The recording medium may be in any form as long as it can store a program and can be read by the device, such as a CD-ROM or a memory card.

The communication unit 11d performs data communication between the server 13 and the settlement device 12, which are connected via the network 14. The communication unit 11d can also perform data communication with other registration devices 11 connected via the network 14.

The keyboard 11e is a keyboard dedicated to a registration device on which known keys such as a ten-key, a multiplication key, a subtotal key, a transmission key, and a clear key are disposed. The keyboard 11e may be a general-purpose keyboard provided with a ten-key to which functions such as a multiplication key, a subtotal key, a transmission key, and a clear key are assigned.

The scanner 11f reads a code symbol such as a barcode or a two-dimensional data code. The scanner 11f may be a type of scanner that reads the code symbol by scanning with a laser beam, or may be a type of scanner that reads the code symbol from an image captured by an image-capturing device.

The touch panel 11g is a device having both an input device and a display device. The touch panel 11g displays information to a store clerk who is an operator of the registration device 11, and receives an operation input by the store clerk.

The customer display 11h displays information for a customer who registers the commodity to be purchased in the registration device 11.

The printer 11i issues a receipt by printing various character strings or images on receipt paper. As this type of printer 11i, for example, a thermal printer or a dot impact printer can be used.

The drawer opening mechanism 11j opens a drawer for storing cash or cash vouchers such as gift certificates and coupons.

As the hardware of such a registration device 11, for example, an existing POS terminal can be used.

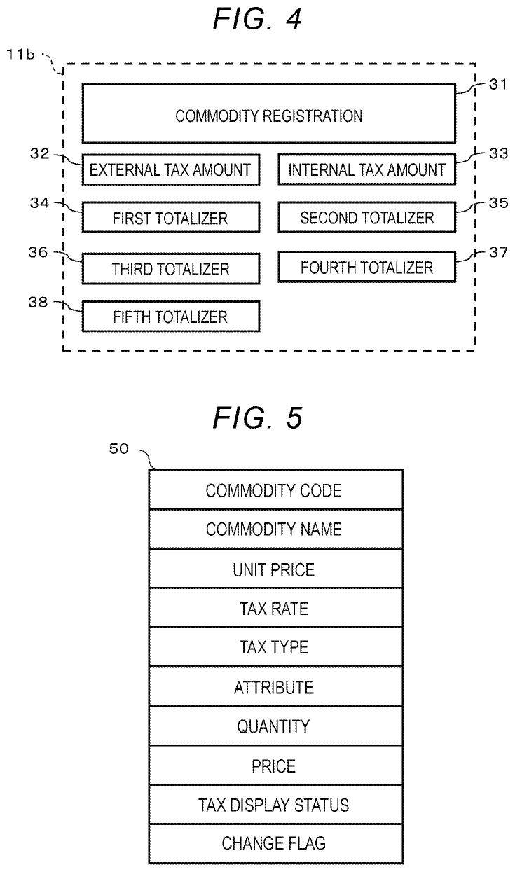

As illustrated in FIG. 4, in the registration device 11, a commodity registration area 31, an external tax amount area 32, an internal tax amount area 33, a first totalizer 34, a second totalizer 35, a third totalizer 36, a fourth totalizer 37, and a fifth totalizer 38 are formed, as work areas, in the volatile area of the main memory 11b.

The commodity registration area 31 is an area for storing commodity sales data 50 (see FIG. 5) generated for each commodity registered for sale as one transaction.

FIG. 5 is a schematic diagram illustrating a main data structure of the commodity sales data 50. The commodity sales data 50 includes data items such as a commodity code, a commodity name, a unit price, a tax rate, a tax type, an attribute, a quantity, a price, a tax display status, and a change flag. The commodity code, commodity name, unit price, tax rate, tax type, and attribute are data of the commodity record 15R. The quantity is the number of sold units. The price is an amount calculated from the unit price and the quantity. The tax display status and the change flag will be described later.

The external tax amount area 32 is an area for storing a tax amount that is not included in the price, that is, a so-called an external tax amount, among the tax amount of the tax imposed on the consumption of the commodity registered for sale as one transaction. The internal tax amount area 33 is an area for storing the tax amount included in the price, that is, a so-called an internal tax amount, among the tax amount of the tax imposed on the consumption of the commodity registered for sale as one transaction.

The first totalizer 34 is an area for summing up the prices of commodities registered for sale as one transaction. The second totalizer 35 is an area for summing up the prices of commodities whose tax type is the external tax and whose tax rate is the normal tax rate among the commodities registered for sale as one transaction. The third totaling unit 36 is an area for summing up the prices of commodities whose tax type is the external tax and whose tax rate is the reduced tax rate among the commodities registered for sale as one transaction. The fourth totalizer 37 is an area for summing up the prices of commodities whose tax type is the internal tax and whose tax rate is the normal tax rate among the commodities registered for sale as one transaction. The fifth totalizer 38 is an area for summing up the prices of the commodities whose tax type is the internal tax and whose tax rate is the reduced tax rate among the commodities registered for sale as one transaction.

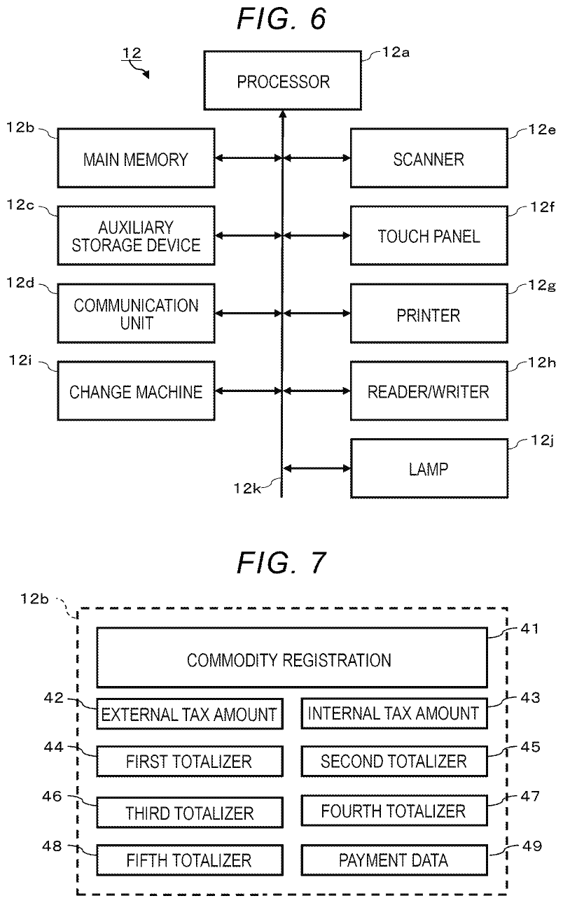

FIG. 6 is a block diagram illustrating a main circuit configuration of the settlement device 12. The settlement device 12 includes a processor 12a, a main memory 12b, an auxiliary storage device 12c, a communication unit 12d, a scanner 12e, a touch panel 12f, a printer 12g, a reader/writer 12h, a change machine 12i, a lamp 12j, and a system transmission path 12k. The system transmission path 12k includes an address bus, a data bus, a control signal line, and the like. The system transmission path 12k connects the processor 12a, the main memory 12b, the auxiliary storage device 12c, the communication unit 12d, the scanner 12e, the touch panel 12f, the printer 12g, the reader/writer 12h, the change machine 12i, and the lamp 12j to each other. A computer of the settlement device 12 is configured by connecting the processor 12a, the main memory 12b, and the auxiliary storage device 12c through the system transmission path 12k.

The processor 12a corresponds to a central part of the computer. The processor 12a controls each unit to implement various functions as the settlement device 12 according to an operating system or an application program. The processor 12a is, for example, a CPU.

The main memory 12b corresponds to a main storage portion of the computer. The main memory 12b includes a nonvolatile memory area and a volatile memory area. The main memory 12b stores an operating system or an application program in the nonvolatile memory area. The main memory 12b may store data necessary for the processor 12a to execute processing for controlling each unit in the nonvolatile or volatile memory area. The main memory 12b uses the volatile memory area as a work area in which data is appropriately rewritten by the processor 12a. The nonvolatile memory area is, for example, a ROM. The volatile memory area is, for example, a RAM.

The auxiliary storage device 12c corresponds to an auxiliary storage portion of the computer. For example, an EEPROM, an HDD, an SSD, or the like can be the auxiliary storage device 12c. The auxiliary storage device 12c stores data used when the processor 12a performs various processes, data generated by the processes in the processor 12a, and the like. The auxiliary storage device 12c may store the application program described above.

The application program stored in the main memory 12b or the auxiliary storage device 12c includes a control program described regarding information processing executed by the settlement device 12, that is, a so-called settlement program. A method for installing the settlement program in the main memory 12b or the auxiliary storage device 12c is not particularly limited. The settlement program can be recorded on a removable recording medium, or distributed by communication via the network 14 to be installed in the main memory 12b or the auxiliary storage device 12c. The recording medium may be in any form as long as the recording medium can store a program and can be read by the device, such as a CD-ROM or a memory card.

The communication unit 12d performs data communication between the server 13 and the registration device 11, which are connected via the network 14. The communication unit 12d can also perform data communication with other settlement devices 12 connected via the network 14.

The scanner 12e reads a code symbol such as a barcode or a two-dimensional data code. The scanner 12e may be a type of scanner that reads the code symbol by scanning with a laser beam, or may be a type of scanner that reads the code symbol from an image captured by an image-capturing device.

The touch panel 12f is a device having both an input device and a display device. The touch panel 12f displays information to a customer who is an operator of the settlement device 12, and receives an operation input by the customer.

The printer 12g issues a receipt by printing various character strings or images on receipt paper. As this type of printer 12g, for example, a thermal printer or a dot impact printer can be used.

The reader/writer 12h has a function of reading data recorded on a medium such as a card or a smartphone and a function of writing data to the medium. The card may include a membership card called as a member's card or a point card, in addition to a settlement card such as a credit card, a debit card, an electronic money card, or a prepaid card. The reader/writer 12h may be any one of a magnetic type, contact type, and non-contact type device, and may include a plurality of types of devices.

The change machine 12i receives coins and bills to be inserted. The change machine 12i discharges coins and bills as change.

The lamp 12j includes, for example, a two-color light-emitter of red and green (e.g., a visual indicator). The lamp 12j is associated with the settlement device 12 and provided at the top of a pole erected in the vicinity to be turned on in red (e.g., providing a first visual indication) or green (e.g., providing a second visual indication), for example, depending on the state of the corresponding settlement device 12.

As the hardware of such a settlement device 12, for example, a POS terminal corresponding to an existing self-service type commodity sales data processing system, so-called a self-service cash register can be used.

As illustrated in FIG. 7, in the settlement device 12, a commodity registration area 41, an external tax amount area 42, an internal tax amount area 43, a first totalizer 44, a second totalizer 45, a third totalizer 46, a fourth totalizer 47, a fifth totalizer 48, and a payment data area 49 are formed, as work areas, in the volatile area of the main memory 12b. The commodity registration area 41, the external tax area 42, internal tax area 43, the first totalizer 44, the second totalizer 45, the third totalizer 46, the fourth totalizer 47 and the fifth totalizer 48 have the same functions as the work areas 31 to 38 with the same name provided in the registration device 11, and thus the description thereof will be omitted.

The payment data area 49 stores payment data. For example, in the case of cash payment, data related to the deposit amount and the change amount is stored in the payment data area 49. For example, in the case of credit card payment, data related to the payment amount by the credit card is stored in the payment data area. For example, in the case of electronic money payment, data related to the payment amount by electronic money is stored in the payment data area.

Next, an operation of one registration device 11 constituting the commodity sales data processing system 10 and one settlement device 12 that processes the settlement of a transaction in which the purchased commodities are registered for sale in the registration device 11 will be described. The settlement device 12 is one of three settlement devices 12-1, 12-2, and 12-3 disposed in a checkout lane where the registration device 11 is installed. The settlement device 12 can be one of three settlement devices 12-1, 12-2, and 12-3 disposed in a checkout lane different from the checkout lane where the registration device 11 is installed.

In describing the operation, a case of processing a transaction with a customer who purchases 15 units in total from the following 5 items A to E will be described as an example:
Item A: commodity name “commodity A”, unit price “100 yen”, tax type “tax-exempt”, attribute “tax free”, purchased unit “1”.
Item B: commodity name “commodity B”, unit price “100 yen”, tax type “external tax”, attribute “normal tax rate”, purchased unit “2”.
Item C: commodity name “commodity C”, unit price “100 yen”, tax type “internal tax”, attribute “normal tax rate”, purchased unit “3”.
Item D: commodity name “commodity D”, unit price “100 yen”, tax type “external tax”, attribute “reduced tax rate”, purchased unit “4”.
Item E: commodity name “commodity E”, unit price “100 yen”, tax type “internal tax”, attribute “reduced tax rate”, purchased unit “5”.

For such a transaction, a store clerk who is an operator of the registration device 11 usually operates the registration device 11 as follows to perform the registration for sales of the purchased commodity:
Operation 1: The code symbol of the commodity A is scanned by the scanner 11f.
Operation 2: After the purchased unit “2” is entered using the ten-key and the multiplication key is input, the code symbol of the commodity B is scanned by the scanner 11f.
Operation 3: After the purchased unit “3” is entered using the ten-key and the multiplication key is input, the code symbol of the commodity C is scanned by the scanner 11f.
Operation 4: After the purchased unit “4” is entered using the ten-key and the multiplication key is input, the code symbol of the commodity D is scanned by the scanner 11f.
Operation 5: After the purchased unit “5” is entered using the ten-key and the multiplication key is input, the code symbol of the commodity E is scanned by the scanner 11f.

A sequence of operations 1 to 5 is not particularly limited. Regarding the operations 1 to 5, the input of the multiplication key may be omitted depending on a model of the registration device 11. Alternatively, the code symbol may be scanned first, and the purchased unit may be input later.

FIGS. 8 to 10 are flowcharts illustrating the procedure of the scanning process executed by the processor 11a of the registration device 11 in response to the operations 1 to 5. The processor 11a of the registration device 11 executes the scanning process according to a registration program stored in the main memory 11b or the auxiliary storage device 11c. The procedure of the scanning process is not limited thereto. If a similar result can be obtained, the procedure can be modified in various ways.

When a code symbol is scanned by the scanner 11f, the processor 11a starts the scanning process. First, the processor 11a confirms whether or not a commodity code is included in data of the code symbol, as ACT 1. When it is confirmed that the commodity code is not included, the processor 11a determines NO in ACT 1 and executes other processes. For example, when a code symbol printed on a discount ticket is scanned, the processor 11a executes a discount process.

In the operations 1 to 5, the commodity code is included in the data of code symbol. The processor 11a determines YES in ACT 1 and, and proceeds to ACT 2. The processor 11a acquires commodity data related to the commodity identified by the commodity code, as ACT 2. Specifically, the processor 11a controls the communication unit 11d so as to make an inquiry about commodity data to the server 13. By this control, an inquiry command for commodity data is sent from the communication unit 11d to the server 13. A commodity code obtained from the code symbol data is included in the inquiry command.

The inquiry command is transmitted to the server 13 via the network 14. The server 13 that receives the inquiry command retrieves the commodity master file 15 and reads the commodity record 15R in which the commodity code included in the inquiry command is described. Then, the server 13 transmits a response command including data of the commodity record 15R to the registration device 11 that is an inquiry command transmission source. The response command is received by the communication unit 11d of the registration device 11 via the network 14. Thus, the processor 11a acquires commodity data of the commodity identified by the commodity code, that is, the commodity name (e.g., a type of commodity), the unit price, the tax rate, the tax type, the attribute, and the like.

The processor 11a that acquires the commodity data calculates the price by multiplying the unit price of the commodity data by the quantity, as ACT 3. Then, the processor 11a adds the price to the first totalizer 34, as ACT 4. Incidentally, in the process of ACT 3, when a multiplier is input by a ten-key K1 and a multiplication key K3 before scanning, the multiplier is a quantity. When no multiplier is input, “1” is the quantity. That is, in the operation 1, the quantity is “1”. In the operation 2, the quantity is “2”. In the operations 3, 4, and 5, the quantities are “3”, “4”, and “5”, respectively.

The processor 11a confirms whether or not the tax type of the commodity data is “1”, as ACT 5. Here, when it is confirmed that the tax type is “1” (i.e., the commodity data of the commodity identified by the commodity code indicates that the commodity is a tax-exempt commodity), the processor 11a determines YES in ACT 5, and proceeds to ACT 6. The processor 11a sets the tax display status to “1”, as ACT 6. The tax display status is 3-bit data. That is, the tax display status can take a value from “0” to “7”. The tax display status is stored in the volatile area of the main memory 11b.

When it is confirmed that the tax type is other than “1”, the processor 11a determines NO in ACT 5 and proceeds to ACT 7. That is, in the case of commodity data of an external tax commodity for which the tax amount is not included in the price or an internal tax commodity for which the tax amount is included in the price, the processor 11a confirms whether or not the tax type of the commodity data is “2”, as ACT 7. When it is confirmed that the tax type is “2”, that is, in the case of the commodity data of the external tax commodity, the processor 11a determines YES in ACT 7 and proceeds to ACT 8. The processor 11a executes an external tax process, as ACT 8.

When the tax type is “3”, that is, in the case of the commodity data of an internal tax commodity, the processor 11a determines NO in ACT 7 and proceeds to ACT 9. The processor 11a executes an internal tax process, as ACT 9.

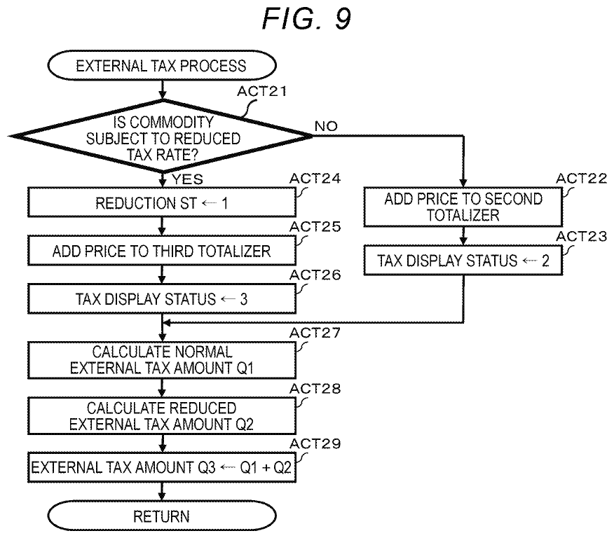

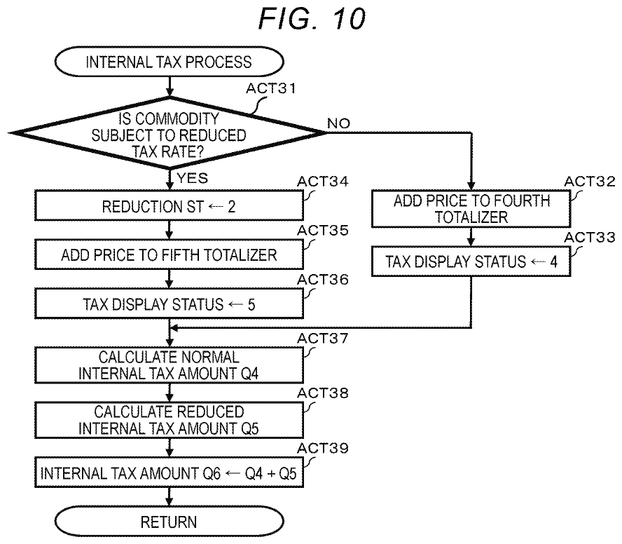

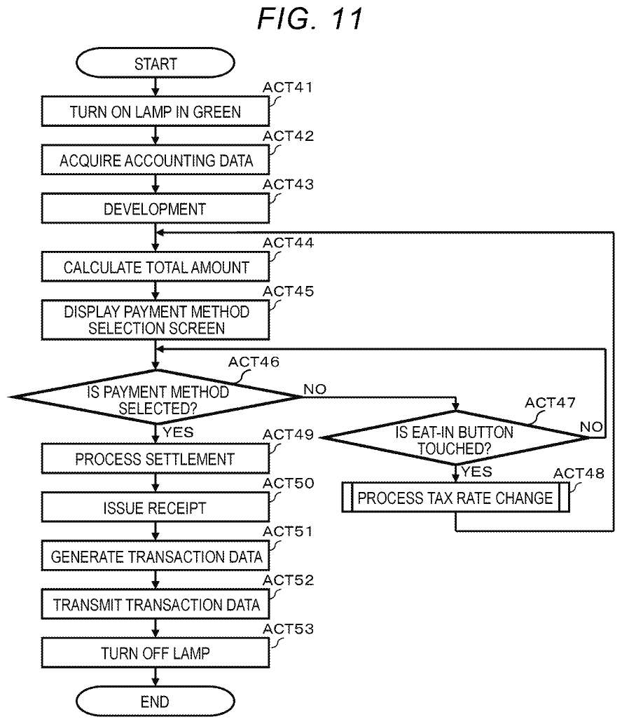

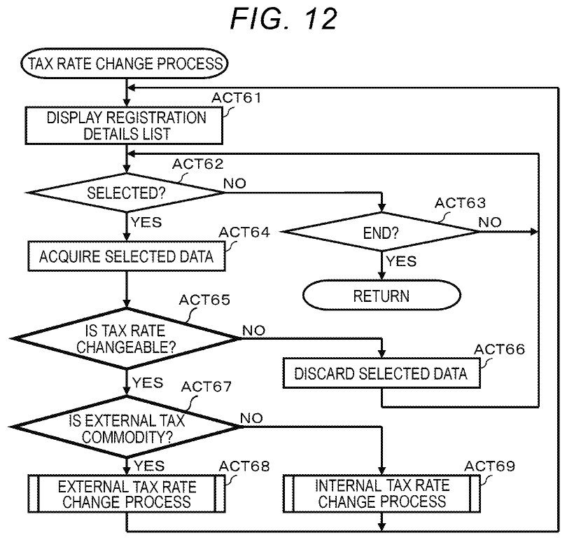

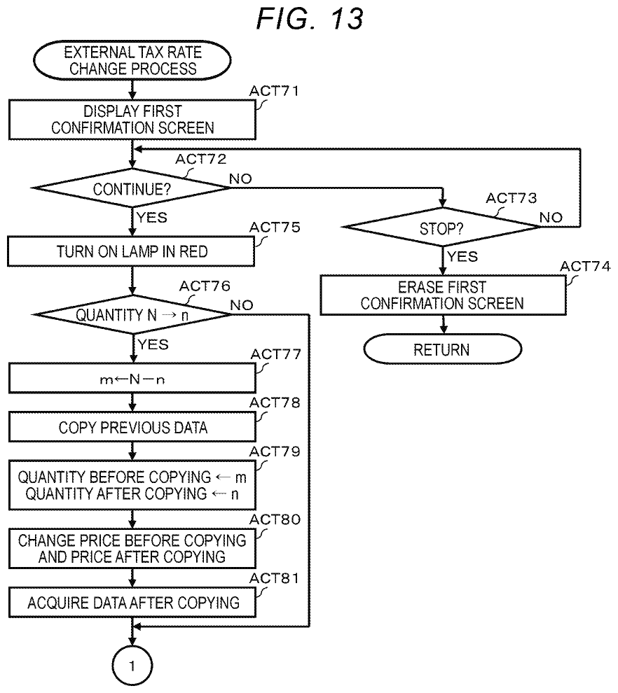

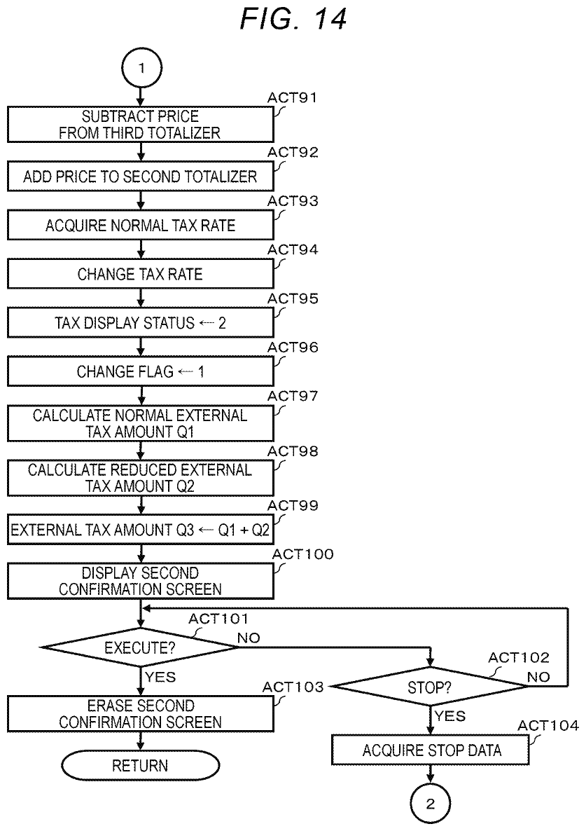

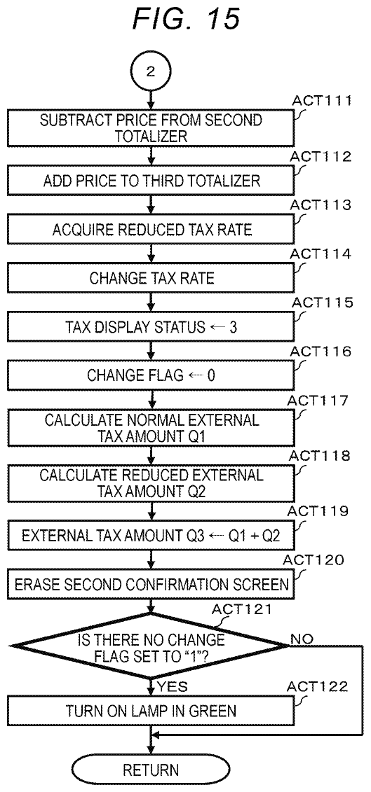

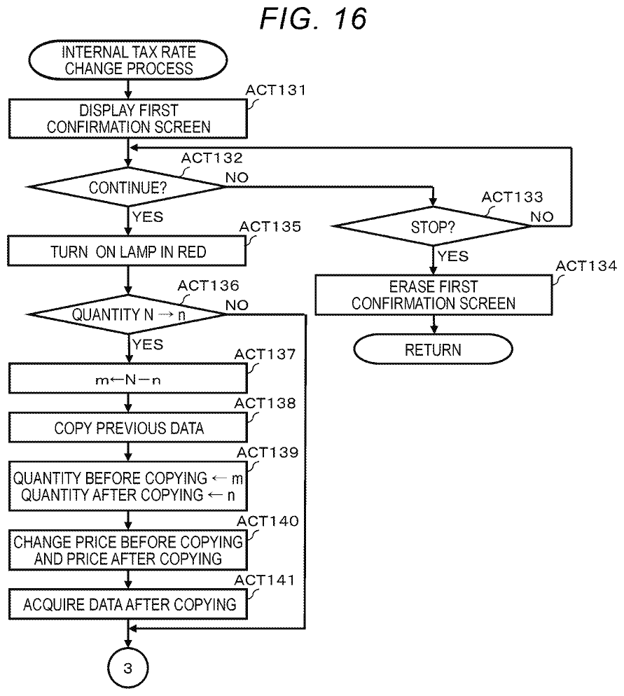

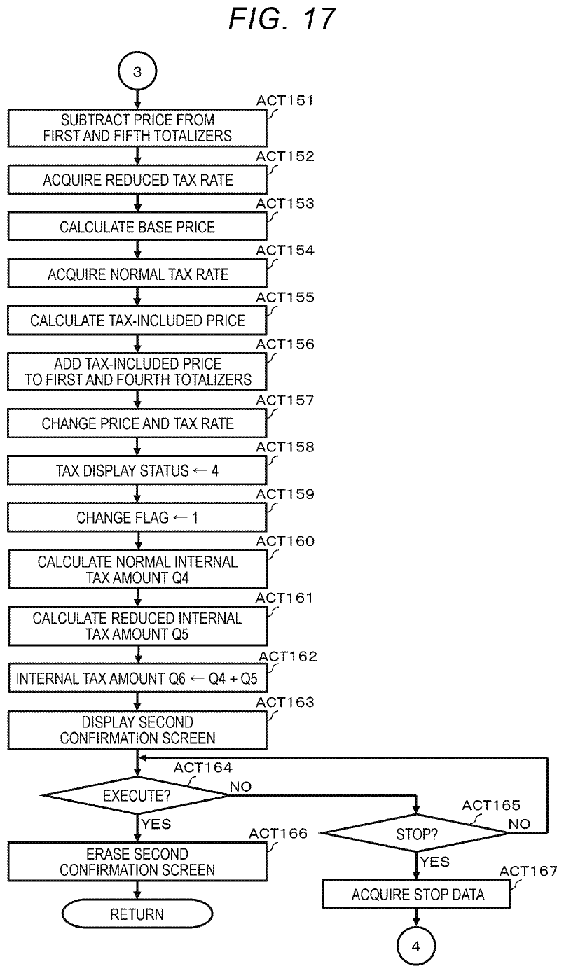

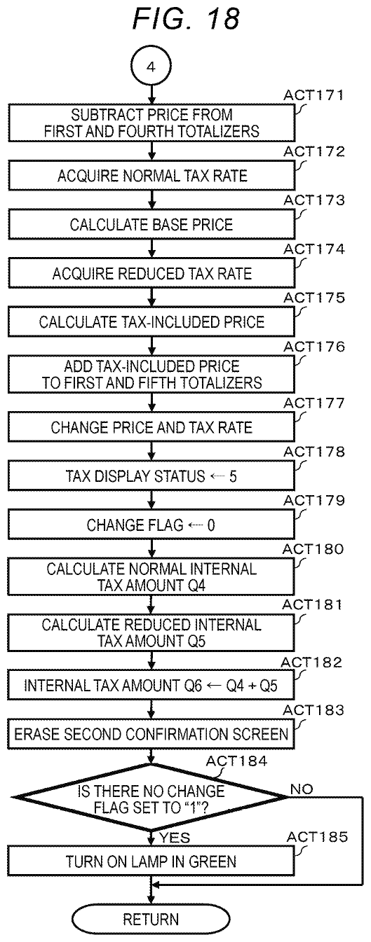

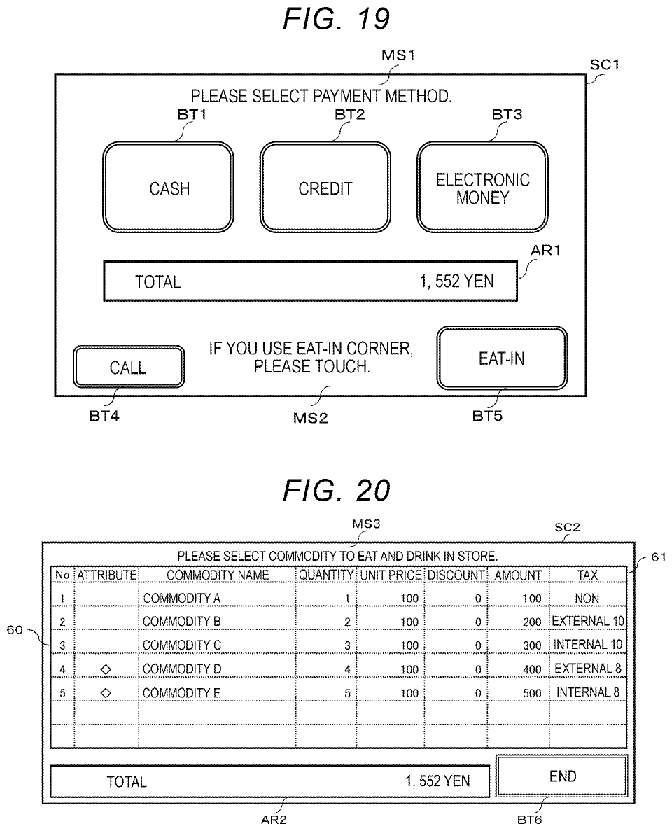

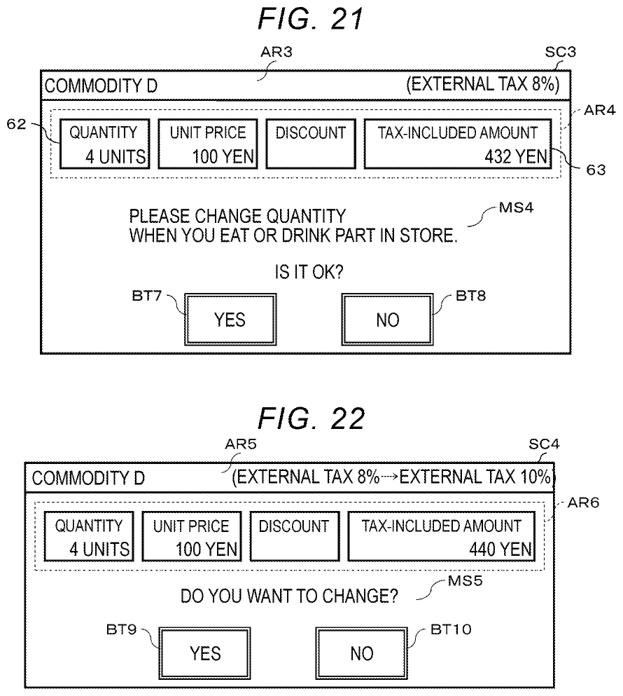

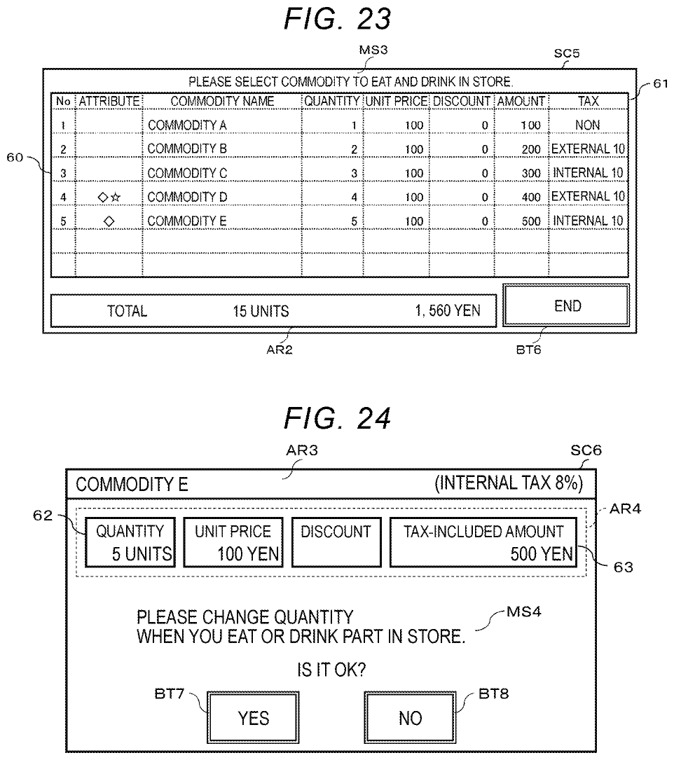

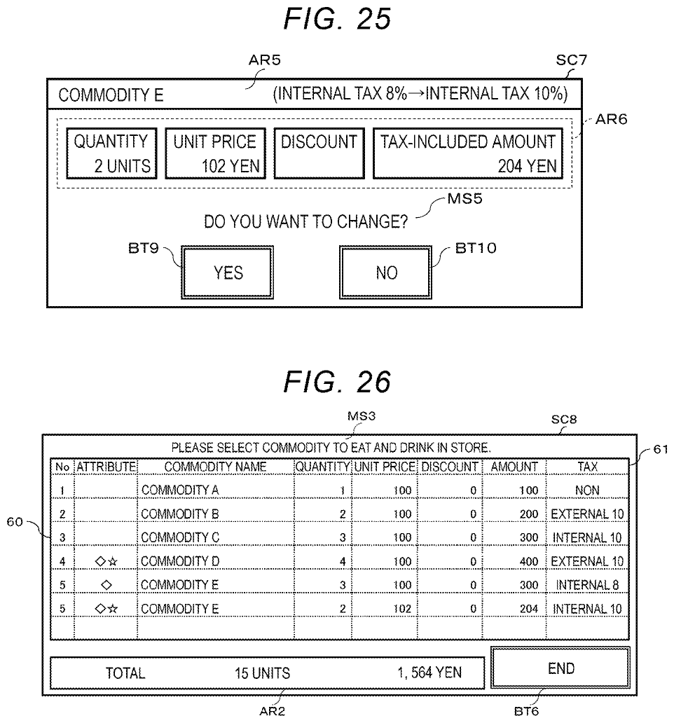

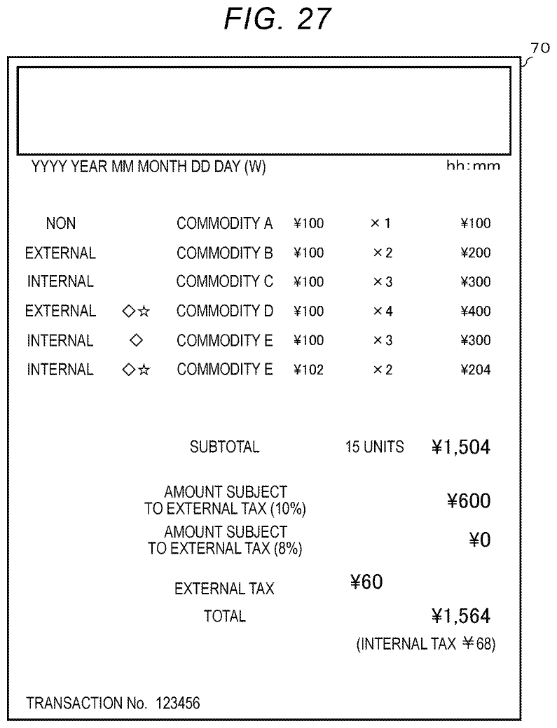

FIG. 9 is a flowchart illustrating a main procedure of the external tax process. In the case of the operation 2 or operation 4, the external tax process is executed. When entering the external tax process, the processor 11a confirms whether or not the commodity specified by the scanned commodity code is a reduced tax rate commodity based on the attribute of the commodity data, as ACT 21.

In the case of the operation 2, the commodity is not the reduced tax rate commodity. The processor 11a determines NO in ACT 21 and proceeds to ACT 22. The processor 11a adds the price to the second totalizer 35, as ACT 22. The price is calculated by the process of ACT 3. The processor 11a sets the tax display status to “2”, as ACT 23.

In the case of the operation 4, the commodity is a reduced tax rate commodity. The processor 11a determines YES in ACT 21 and proceeds to ACT 24. The processor 11a sets a reduction status to “1”, as ACT 24. The processor 11a adds the price to the third totalizer 36, as ACT 25. The processor 11a sets the tax display status to “3”, as ACT 26.

When the tax display status is set to “2” or “3” by the process of ACT 23 or ACT 26, the processor 11a proceeds to ACT 27. The processor 11a calculates a normal external tax amount Q1 from an amount P1 of the second totalizer 35 and the normal tax rate 10% (=0.1) by the following expression (1), as ACT 27.

Q1=P1*0.1 (1)

The processor 11a calculates a reduced external tax amount Q2 from an amount P2 of the third totalizer 36 and the reduced tax rate 8% (=0.08) by the following expression (2), as ACT 28.

Q2=P2*0.08 (2)

Then, the processor 11a updates the external tax amount Q3 in the external tax amount area 32 to a sum of the normal external tax amount Q1 and the reduced external tax amount Q2, as ACT 29. Thus, the processor 11a ends the external tax process.

FIG. 10 is a flowchart illustrating the main procedure of the internal tax process. In the case of the operation 3 or 5, the internal tax process is executed. When entering the internal tax process, the processor 11a confirms whether or not the commodity specified by the scanned commodity code is a reduced tax rate commodity based on the attribute of the commodity data, as ACT 31.

In the case of the operation 3, the commodity is not a reduced tax rate commodity. The processor 11a determines NO in ACT 31 and proceeds to ACT 32. The processor 11a adds the price to the fourth totalizer 37, as ACT 32. The processor 11a sets the tax display status to “4”, as ACT 33.

In the case of the operation 5, the commodity is a reduced tax rate commodity. The processor 11a determines YES in ACT 31 and proceeds to ACT 34. The processor 11a sets the reduction status to “2”, as ACT 34. The processor 11a adds the price to the fifth totalizer 38, as ACT 35. The processor 11a sets the tax display status to “5”, as ACT 36.

When the tax display status is set to “4” or “5” by the process of ACT 33 or ACT 36, the processor 11a proceeds to ACT 37. The processor 11a calculates a normal internal tax amount Q4 from an amount P3 of the fourth totalizer 37 and the normal tax rate 10% (=0.1) by the following expression (3), as ACT 37.

Q4=P3−[P3/(1+0.1)] (3)

The processor 11a calculates a reduced internal tax amount Q5 from the amount P4 of the fifth totalizer 38 and the reduced tax rate (=0.08) by the following expression (4), as ACT 38.

Q5=P4−[P4/(1+0.08)] (4)

Then, the processor 11a updates the internal tax amount Q6 of the internal tax amount area 33 to a sum of the normal internal tax amount Q4 and the reduced internal tax amount Q5, as ACT 39. Thus, the processor 11a ends the internal tax process.

Description will return to FIG. 8. When the tax display status is set to “1” in ACT 6, or the external tax process of ACT 8 or the internal tax process of ACT 9 is completed, the processor 11a proceeds to ACT 10. The processor 11a generates commodity sales data 50, as ACT 10. That is, the processor 11a generates the commodity sales data 50 from the commodity code, the commodity name, the unit price, the tax rate, the tax type, and the attribute of commodity data obtained by the process of ACT 2; the quantity and the price obtained by the process of ACT 3; the tax display status obtained by the process ACT 6, ACT 23, ACT 26, ACT 33, or ACT 36; and the change flag of default value “0”.

Thus, the tax display status is set to “1” in the commodity sales data of the tax-exempt commodity. The tax display status is set to “2” in the commodity sales data 50 of a commodity whose tax type is the external tax and whose tax rate is the normal tax rate. The tax display status is set to “3” in the commodity sales data 50 of a commodity whose tax type is the external tax and whose tax rate is the reduced tax rate. The tax display status is set to “4” in the commodity sales data 50 of a commodity whose tax type is the internal tax and whose tax rate is the normal tax rate. The tax display status is set to “5” in the commodity sales data 50 of a commodity whose tax type is the internal tax and whose tax rate is the reduced tax rate. The change flag is “0” at this point in time.

When the generation of the commodity sales data 50 is completed, the processor 11a registers the commodity sales data 50 in the commodity registration area 31, as ACT 11. The processor 11a displays a registration screen on the touch panel 11g and the customer display 11h based on all the commodity sales data 50 registered in the commodity registration area 31, as ACT 12.

Thus, the processor 11a ends the scanning process. Then, when the code symbol is scanned with the next operation, the processor 11a starts the scanning process again.

In this way, when the operations 1 to 5 are completed, the commodity sales data 50 of all 5 items (commodity A, commodity B, commodity C, commodity D, and commodity E) purchased by the customer is registered in the commodity registration area 31. In this case, the commodity sales data 50 is registered at the reduced tax rate 8% for both the commodity D and the commodity E, which are subject to the reduced tax rate. That is, the commodity D and the commodity E are processed as take-out commodities.

In the first totalizer 34, a total amount of 1,500 yen of a sales amount 100 yen of the commodity A, a sales amount 200 yen of the commodity B, a sales amount 300 yen of the commodity C, a sales amount 400 yen of the commodity D, and a sales amount 500 yen of the commodity E is stored. In the second totalizer 35, a sales price of 200 yen of the commodity B whose tax type is the external tax and whose tax rate is the normal tax rate is stored. In the third totalizer 36, a sales price of 400 yen of the commodity D whose tax type of the external tax and whose tax rate is the reduced tax rate is stored. In the fourth totalizer 37, a sales price of 300 yen of the commodity C whose tax type is the internal tax and whose tax rate is the normal tax rate is stored. In the fifth totalizer 38, a sales price of 500 yen of the commodity E whose tax type is the internal tax and whose tax rate is the reduced tax rate is stored. In the external tax amount area 32, 52 yen, which is the total amount of an external tax amount of 20 yen with a normal tax rate of 10% for the amount of 200 yen of the second totalizer 35 and an external tax amount of 32 yen with a reduced tax rate of 8% for the amount of 400 yen of the third totalizer 36, is stored. In the internal tax amount area 33, 64 yen, which is the total amount of an internal tax amount of 27 yen with a normal tax rate of 10% for the amount of 300 yen of the third totalizer 36 and an internal tax amount of 37 yen with a reduced tax rate of 8% for the amount of 500 yen of the fifth totalizer 38 is stored.

When the operations 1 to 5 are completed, the store clerk inputs a subtotal key. Then, 1,552 yen, which is the total amount (cost) of the amount of 1,500 yen of the first totalizer 34 and the amount of 52 yen of the external tax amount area 32 (i.e., the total cost of the transaction), is displayed on the first display 109 and the second display 110. The store clerk then inputs a transmission key. Then, the checkout data is transmitted from the registration device 11 to the server 13 via the network 14. The checkout data includes each data of the commodity registration area 31, the external tax area 32, the internal tax area 33, the first totalizer 34, the second totalizer 35, the third totalizer 36, the fourth totalizer 37, and the fifth totalizer 38. A unique transaction code is associated with the checkout data. The transaction code is generated by the registration device 11. The transaction code may be generated by the server 13.

The transaction code associated with the checkout data is transmitted from the server 13 to any settlement device 12 via the network 14. When a settlement process is possible, the settlement device 12 that receives the transaction code transmits information notifying that settlement is possible to the registration device 11 that is a transaction code transmission source. In this case, the information may be transmitted directly to the registration device 11, or may be transmitted through the server 13. In the embodiment in which the transaction code is generated by the server 13, the registration device 11 that is the transaction code transmission source is a registration device 11 that transmits checkout data associated with the transaction code.

In the registration device 11 that receives the information, information for identifying the settlement device 12 that is the information transmission source is displayed on the first display 109. Accordingly, the store clerk instructs the customer to go to the settlement device 12 which is the transaction code transmission destination to perform checkout. When receiving this instruction, the customer moves to a place of the settlement device 12 and usually operates the settlement device 12 as follows to perform checkout for the purchased commodity.

The transmission key of the registration device 11 may not be a single key. A plurality of transmission keys may be provided in the registration device 11 corresponding to each settlement device 12. In this case, the transaction code is output to the settlement device 12 corresponding to the transmission key input by the operation. The transaction code may be transmitted directly to the settlement device 12, or may be transmitted through the server 13. The transmission key may be a physical key disposed on the keyboard 11e, or may be a software key when the first display 109 is a touch panel.
Operation 6: A payment method is selected from a payment method selection screen displayed on the touch panel 12f.
Operation 7: A payment operation of the price is performed according to the payment method.

Here, it is assumed that the customer eats and drinks all commodities for the commodity D and only 2 commodities for the commodity E at an eat-in corner, among the commodities D and E which are beverages or foods (e.g., first and second types of commodities) for which a reduced tax rate is set. In that case, the customer performs the following operations on the settlement device 12 before the operation 6:
Operation 11: Make an eat-in declaration.
Operation 12: Select the commodity D to eat and drink at the eat-in corner.
Operation 13: Instruct the execution of tax amount recalculation.
Operation 14: Select the commodity E to eat and drink at the eat-in corner.
Operation 15: Input “2”, which is the number (quantity) of commodities to eat and drink, and instruct the execution of tax amount recalculation.

After completing the operations 11 to 15 described above, the customer performs the operations 6 and 7. Thus, the settlement device 12 settles the transaction with the customer.

FIGS. 11 to 18 are flowcharts illustrating procedures of the main processes executed by the processor 12a of the settlement device 12 in response to the operations 11 to 15. FIGS. 19 to 26 are transition examples of screens displayed on the touch panel 12f. FIG. 27 is an example of a receipt 70 printed and issued by the printer 12g. The processor 12a of the settlement device 12 executes information processing according to the procedures illustrated in the flowcharts of FIGS. 11 to 18 according to a settlement program stored in the main memory 12b or the auxiliary storage device 12c. The procedure of information processing is not limited thereto. If a similar result can be obtained, the procedure can be modified in various ways.

The processor 12a of the settlement device 12 that receives the transaction code transmitted from the server 13 or the registration device 11 starts information processing of the procedure illustrated in FIG. 11. First, the processor 12a performs control so that the lamp 12j is turned on in green, as ACT 41, so as to provide a first indication in response to receiving the transaction code. By this control, the lamp 12j is turned on in green. By turning on the lamp 12j in green, the store clerk can recognize that the checkout is being performed by the settlement device 12 corresponding to the lamp 12j. In contrast, providing a light of a different color may be used as a second indication, in some embodiments.

The processor 12a acquires checkout data, as ACT 42. Specifically, the processor 12a controls the communication unit 12d to transmit a request command for the checkout data to the server 13. By this control, the request command is transmitted from the communication unit 12d to the server 13 via the network 14. The transaction code received from the server 13 or the registration device 11 is included in the request command.

When the request command is received, the server 13 detects the checkout data associated with the transaction code included in the command and transmits the checkout data to the settlement device 12 that is the command transmission source. The checkout data is received by the settlement device 12 that is the command transmission source via the network 14. Thus, the processor 12a of the settlement device 12 can acquire the checkout data.

The processor 12a that acquires the checkout data develops the checkout data in a work area of the main memory 12b, as ACT 42. That is, the processor 12a stores the data of the commodity registration area 31 in the commodity registration area 41, stores the data of the external tax amount area 32 in the external tax amount area 42, and stores the data of the internal tax amount area 33 in the internal tax amount area 43. Similarly, the processor 12a stores the data of the first totalizer 34 in the first totalizer 44, stores the data of the second totalizer 35 in the second totalizer 45, stores the data of the third totalizer 36 in the third totalizer 46, stores the data in the fourth totalizer 37 in the fourth totalizer 47, and stores the data of the fifth totalizer 38 in the fifth totalizer 48.

Here, a computer having the processor 12a as a main body constitutes an acquisition unit that acquires data of the commodity registered in the registration device 11 by executing the process of ACT 42 in cooperation with the communication unit 12d. The commodity data is at least a commodity code and a tax rate among data items constituting the commodity sales data 50. The commodity data may further include the tax type. The quantity may be included in the commodity data.

The processor 12a calculates the total amount (i.e., the total cost of the transaction) by adding the amount of the first totalizer 44 and the amount of the external tax amount area 42, as ACT 44. Then, the processor 12a displays a payment method selection screen SC1 (see FIG. 19) on the touch panel 12f, as ACT 45.

FIG. 19 is a display example of the payment method selection screen SC1. As illustrated in FIG. 19, on the payment method selection screen SC1, images of a cash button BT1, a credit button BT2, and an electronic money button BT3 for selecting a payment method are displayed together with a message MS1 prompting selection of the payment method. On the payment method selection screen SC1, a total amount area AR1 (i.e., the total cost area) is formed together with images of a call button BT4 and an eat-in button BT5, and the total amount calculated by the process of ACT 44 is displayed in the total amount area AR1.

The cash button BT1 is a button image for receiving a declaration of cash payment. The credit button BT2 is a button image for receiving a declaration of credit card payment. The electronic money button BT3 is a button image for receiving a declaration of electronic money payment. The call button BT4 is a button image for receiving a clerk call. The eat-in button BT5 is a button image for receiving a declaration, by the customer's own operation, that at least a part of the purchased beverages or foods is eaten at the eat-in corner. A message MS2 for guiding an operation to a customer who uses the eat-in corner is displayed on a part of the payment method selection screen SC1 in association with the eat-in button BT5.

This embodiment suggests three payment methods of cash, credit card, and electronic money that can be used in the settlement device 12, but the payment method is not limited thereto. For example, a payment method using accumulated service points may be included. The credit card may be divided into an own company's credit card and other company's credit card. Similarly, the electronic money may be divided into the own company's electronic money and other company's electronic money.

A customer who confirms the payment method selection screen SC1 decides whether or not to use the eat-in corner. A customer who decides not to use the eat-in corner touches one of the button images BT1, BT2, and BT3 of a desired payment method. That is, a customer who wishes to pay by cash touches the cash button BT1. A customer who wishes to pay by a credit card touches the credit button BT2. A customer who wishes to pay by electronic money touches the electronic money button BT3. This operation corresponds to the operation 6 described above. On the other hand, a customer using the eat-in corner touches the eat-in button BT5 before touching one of the button images BT1, BT2, and BT3 of the desired payment method. This operation corresponds to the operation 11 described above.

The processor 12a causing the payment method selection screen SC1 to be displayed confirms whether or not the payment method is selected, as ACT 46. When the payment method is not selected, the processor 12a determines NO in ACT 46 and proceeds to ACT 47. The processor 12a confirms whether or not the eat-in button BT5 is touched, as ACT 47. When the eat-in button BT5 is not touched, the processor 12a determines NO in ACT 47 and returns to ACT 46. Here, the processor 12a waits for a payment method to be selected, as ACT 46, or waits for the eat-in button BT5 to be touched, as ACT 47.

In this waiting state, when detecting that the eat-in button BT5 is touched, the processor 12a determines YES in ACT 47 and proceeds to ACT 48. The processor 12a executes a tax rate change process, as ACT 48.

FIG. 12 is a flowchart illustrating a main procedure of the tax rate change process. When entering the tax rate change process, the processor 12a switches a screen of the touch panel 12f to the registration details list screen SC2 (see FIG. 20), as ACT 61.

FIG. 20 is a display example of the registration details list screen SC2. As illustrated in FIG. 20, a registration details list 60 and an image of an end button BT6 are displayed on the registration details list screen SC2. On the registration details list screen SC2, a total amount area AR2 (i.e., a total cost area) is formed and the total amount is displayed similarly as in the payment method selection screen SC1. Furthermore, in the vicinity of the registration details list 60, a message MS3 prompting the customer to select a commodity to eat and drink in the store using the eat-in corner is displayed.

In the registration details list 60, the commodity name, the quantity, the unit price, the price (amount), the tax mark 61, and the like of the commodity sales data 50 registered in the commodity registration area 41 are displayed in the registration sequence. As an attribute, a diamond mark “⋄” is added to the commodity subject to the reduced tax rate system. In the case of the registration details list screen SC2 in FIG. 20, the diamond mark “⋄” is added to the commodities D and E.

The tax mark 61 is a mark uniquely set for each of the tax display statuses “1” to “5”. In this embodiment, the “none” is set as the tax mark 61 for the tax display status “1” corresponding to the tax-exempt commodity. The “external 10” is set as the tax mark 61 for the tax display status “2” corresponding to the commodity whose tax type is the external tax and whose the tax rate is the normal tax rate. The “external 8” is set as the tax mark 61 for the tax display status “3” corresponding to the commodity whose tax type is the external tax and whose tax rate is the reduced tax rate. The “internal 10” is set as the tax mark 61 for the tax display status “4” corresponding to the commodity whose tax type is the internal tax and whose tax rate is the normal tax rate. The “internal 8” is set as the tax mark 61 for the tax display status “5” corresponding to the commodity whose tax type is the internal tax and whose tax rate is the reduced tax rate.

The customer who confirms the registration details list screen SC2 touches a row in which information on a commodity is displayed in order to select the commodity to eat and drink in the store from the registration details list 60. For example, when eating and drinking the commodity D in the store, the customer touches the row in which the commodity name “commodity D” of the commodity D is displayed. This operation corresponds to the operation 12 described above.

The processor 12a causing the registration details list screen SC2 to be displayed confirms whether or not the commodity to eat and drink at the eat-in corner is selected, as ACT 62. When the commodity is not selected, the processor 12a determines NO in ACT 62 and proceeds to ACT 63. The processor 12a confirms whether or not the end button BT6 is touched, as ACT 63. When the end button BT6 is not touched, the processor 12a determines NO in ACT 63 and returns to ACT 62. Here, the processor 12a waits for a commodity to be selected, as ACT 62, or waits for the end button BT6 to be touched, as ACT 63.

In this waiting, when detecting that the commodity is selected, the processor 12a determines YES in ACT 62 and proceeds to ACT 64. The processor 12a acquires the commodity sales data 50 of the selected commodity from the commodity registration area 41, as ACT 64. Hereinafter, the commodity sales data 50 acquired from the commodity registration area 41 is represented as commodity sales data 50a.

Here, the processor 12a constitutes a receiving unit (receiver) that receives a selection of a commodity whose tax rate is to be changed from among the sales commodities by executing the process of ACT 61, the process according to YES in ACT 62, and the process of ACT 64 in cooperation with the touch panel 12f.

The processor 12a confirms whether or not the commodity selected can be changed in the tax rate, as ACT 65. When the attribute included in the commodity sales data 50a is information indicating a reduced tax rate commodity, the tax rate of the selected commodity can be changed. When the attribute is not information indicating a reduced tax rate commodity, the tax rate of the selected commodity cannot be changed.

When the tax rate cannot be changed, the processor 12a determines NO in ACT 65 and proceeds to ACT 66. The processor 12a discards the commodity sales data 50a, as ACT 66. Thereafter, the processor 12a returns to the waiting state of ACT 62.

In the case of the operation 12, the attribute of the selected commodity D is information indicating a reduced tax rate commodity. That is, the tax rate can be changed. The processor 12a determines YES in ACT 65 and proceeds to ACT 67. The processor 12a identifies whether the tax type of the commodity selected is an external tax or an internal tax, as ACT 67. When the tax type is the external tax, the processor 12a determines YES in ACT 67 and proceeds to ACT 68. The processor 12a executes the external tax rate change process, as ACT 68. When the tax type is the internal tax, the processor 12a determines NO in ACT 67 and proceeds to ACT 69. The processor 12a executes the internal tax rate change process, as ACT 69.

In the case of the operation 12, since the selected commodity D is an external commodity, the processor 12a executes the external tax rate change process. FIGS. 13 to 15 are flowcharts illustrating the specific procedure of the external tax rate change process. When entering the external tax rate change process, the processor 12a displays a first confirmation screen SC3 (see FIG. 21) on the touch panel 12f, as ACT 71 in FIG. 13.

FIG. 21 is a display example of the first confirmation screen SC3. The first confirmation screen SC3 is displayed on the touch panel 12f after the operation 12. On the first confirmation screen SC3, a first selected commodity area AR3 and a second selected commodity area AR4 are formed. Images of a “Yes” button BT7 indicating affirmative and a “No” button BT8 indicating negative are displayed. In the first selected commodity area AR3, the commodity name “commodity D”, the tax type, and the tax rate “external tax 8%” of the selected commodity are displayed. In the second selected commodity area AR4, the quantity “4 units”, the unit price “100 yen”, the tax-included amount “432 yen” with a reduced tax rate of 8% included, and the like of the selected commodity are displayed.

In a column 62 of the quantity of the second selected commodity area AR4, the displayed quantity can be changed to a numerical value equal to or less than that quantity. When the number of commodities to eat and drink in the store (n) is different from the displayed quantity (N), the customer changes the quantity N in the column 62 to the number n of commodities to eat and drink (N>n). On the first confirmation screen SC3, a message MS4 prompting the user to change the quantity N is displayed when the number n of commodities to eat and drink in the store is different from the quantity N being displayed. The customer who changes the quantity N touches the column 62 of quantity. Then, since images of numerical buttons to which numerical values (N−1, N−2, . . . , 1) less than the quantity N are respectively assigned are displayed on the first confirmation screen SC3, the customer touches a numerical button to which the number n of commodities to eat and drink in the store is assigned. Then, the quantity N in the column 62 is changed to the number n, and the tax-included amount in the column 63 is also changed accordingly.

The quantity N is not changed after the operation 12. The customer who confirms the first confirmation screen SC3 touches the “Yes” button BT7 to instruct execution of the tax amount recalculation. This operation corresponds to the operation 13.

The processor 12a causing the first confirmation screen SC3 to be displayed confirms whether or not the continuation of the process is instructed, as ACT 72. When the “Yes” button BT7 on the first confirmation screen SC3 is not touched, the processor 12a determines that the continuation of the process is not instructed. When the continuation of the process is not instructed, the processor 12a determines NO in ACT 72 and proceeds to ACT 73. The processor 12a confirms whether or not the stop of the process is instructed, as ACT 73. When the “No” button BT8 on the first confirmation screen SC3 is not touched, the processor 12a determines that the stop of the process is not instructed. When the stop of the process is not instructed, the processor 12a determines NO in ACT 73 and proceeds to ACT 72. Here, the processor 12a waits for an instruction to continue the process in ACT 72 or waits for an instruction to stop the process in ACT 73.

When the stop of the process is instructed, that is, when the “No” button BT8 on the first confirmation screen SC3 is touched, the processor 12a determines YES in ACT 73 and proceeds to ACT 74. The processor 12a erases (i.e., ends the display of) the first confirmation screen SC3, as ACT 74. Then, the processor 12a ends the external tax rate change process and returns to ACT 61 in FIG. 12.

When the continuation of the process is instructed, that is, when the “Yes” button BT7 on the first confirmation screen SC3 is touched, the processor 12a determines YES in ACT 72 and proceeds to ACT 75. The processor 12a controls the lamp 12j to be turned on in red, as ACT 75. By this control, the lamp 12j is turned on in red. When the lamp 12j is turned on in red, the store clerk can recognize that the customer, who performs settlement with the settlement device 12 corresponding to the lamp 12j, is changing the tax rate in order to use the eat-in corner.

The processor 12a confirms whether or not the quantity N is changed to a smaller number n on the first confirmation screen SC3, as ACT 76. In the case of the operation 13, the quantity N is not changed. The processor 12a determines NO in ACT 76 and proceeds to ACT 91 in FIG. 14.

The processor 12a subtracts the price of the commodity sales data 50a from the third totalizer 46, as ACT 91. The processor 12a adds the price of the commodity sales data 50a to the second totalizer 45, as ACT 92.

Next, the processor 12a acquires a normal tax rate of 10%, as ACT 93. The normal tax rate of 10% is set in the auxiliary storage device 12c, for example. The processor 12a changes the tax rate of the commodity sales data 50a to the normal tax rate of 10%, as ACT 94. The processor 12a changes the tax display status of the commodity sales data 50a to “2”, as ACT 95. Furthermore, the processor 12a sets the change flag of the commodity sales data 50a to “1”, as ACT 96.

Thereafter, the processor 12a executes the same processes as the processes of ACT 27 to ACT 29 described above, as ACT 97 to ACT 99. That is, the processor 12a calculates the normal external tax amount Q1 by the expression (1), as ACT 97. The processor 12a calculates the reduced external tax amount Q2 by the expression (2), as ACT 98. Then, the processor 12a updates the external tax amount Q3 in the external tax amount area 42 to the sum of the normal external tax amount Q1 and the reduced external tax amount Q2, as ACT 99.

When the processes of ACT 97 to ACT 99 are completed, the processor 12a causes a second confirmation screen SC4 (see FIG. 22) to be displayed on the touch panel 12f, as ACT 100.

FIG. 22 is a display example of a second confirmation screen SC4. On the second confirmation screen SC4, when the “Yes” button BT7 is touched on the first confirmation screen SC3, a third selected commodity area AR5 and a fourth selected commodity area AR6 are formed in second confirmation screen SC4 displayed on the touch panel 12f. Images of a “Yes” button BT9 indicating affirmative and a “No” button BT10 indicating negative are displayed. In the third selected commodity area AR5, the commodity name “commodity D” of the commodity whose tax rate is changed and the tax type and the tax rate “external tax 8%→external tax 10%” before and after the change are displayed. In the fourth selected commodity area AR6, the quantity “4 units”, the unit price “400 yen”, the tax-included amount “440 yen”, and the like of the commodity D whose tax rate is changed are displayed. A message MS5, which is for confirming with the customer whether or not to execute the tax rate change, is also displayed.

The customer who confirms the second confirmation screen SC4 touches the “Yes” button BT9 when executing the change of the tax rate, and touches the “No” button BT10 when stopping the change of the tax rate.

The processor 12a causing the second confirmation screen SC4 to be displayed confirms whether or not the execution of the tax rate change is instructed, as ACT 101. When the “yes” button BT9 on the second confirmation screen SC4 is not touched, the processor 12a determines that the execution of the tax rate change is not instructed. When the execution of the tax rate change is not instructed, the processor 12a determines NO in ACT 101 and proceeds to ACT 102. The processor 12a confirms whether or not the stop of the tax rate change is instructed, as ACT 102. When the “No” button BT10 on the second confirmation screen SC4 is not touched, the processor 12a determines that the stop of the process is not instructed. When the stop of the process is not instructed, the processor 12a determines NO in ACT 102 and returns to ACT 101. Here, the processor 12a waits for an instruction to execute the tax rate change in ACT 101 or waits for an instruction to stop the tax rate change in ACT 102.

When the execution of the tax rate change is instructed, that is, when the “Yes” button BT9 on the second confirmation screen SC4 is touched, the processor 12a determines YES in ACT 101 and proceeds to ACT 103. The processor 12a erases the second confirmation screen SC4, as ACT 103. Then, the processor 12a ends the external tax rate change process and returns to ACT 61 in FIG. 12.

When the stop of the tax rate change is instructed, that is, when the “No” button BT10 on the second confirmation screen SC4 is touched, the processor 12a determines YES in ACT 102 and proceeds to ACT 104. The processor 12a acquires stop data, as ACT 104. The stop data is the commodity sales data 50 targeted for the processes of ACT 91 to ACT 99. That is, at this point in time, the commodity sales data 50a becomes the stop data.

When the commodity sales data 50a which is the stop data is acquired, the processor 12a proceeds to ACT 111 in FIG. 15. The processor 12a subtracts the price of the commodity sales data 50a from the second totalizer 45, as ACT 111. The processor 12a adds the price of the commodity sales data 50a to the third totalizer 46, as ACT 112.

Next, the processor 12a acquires a reduced tax rate of 8%, as ACT 113. The reduced tax rate 8% is set, for example, in the auxiliary storage device 12c. The processor 12a changes the tax rate of the commodity sales data 50a to the reduced tax rate of 8%, as ACT 113. The processor 12a changes the tax display status of the commodity sales data 50a to “3”, as ACT 115. Furthermore, the processor 12a resets the change flag of the commodity sales data 50a to “0”, as ACT 116.

Thereafter, the processor 12a performs the same processes as the processes of ACT 27 to ACT 29 described above, as ACT 117 to ACT 119. That is, the processor 12a calculates the normal external tax amount Q1 by the expression (1), as ACT 117. The processor 12a calculates the reduced external tax amount Q2 by the expression (2), as ACT 118. Then, the processor 12a updates the external tax amount Q3 of the external tax amount area 42 to the sum of the normal external tax amount Q1 and the reduced external tax amount Q2, as ACT 119.

By executing the processes of ACT 111 to ACT 119 by the processor 12a, data of the commodity registration area 41, the external tax area 42, the internal tax area 43, the first totalizer 44, the second totalizer 45, the third totalizer 46, the fourth totalizer 47, and the fifth totalizer 48 is returned to the state before executing the process of ACT 91.

When the process of ACT 119 is completed, the processor 12a erases the second confirmation screen SC4, as ACT 120. Then, the processor 12a confirms whether or not there is the commodity sales data 50 for which the change flag is set to “1” among all the commodity sales data 50 registered in the commodity registration area 41, as ACT 121. When there is even one commodity sales data 50 for which the change flag is set to “1”, the processor 12a determines NO in ACT 121. The processor 12a ends the external tax rate change process and returns to ACT 61 in FIG. 12.

When there is no commodity sales data 50 for which the change flag is set to “1” in the commodity registration area 41, the processor 12a determines YES in ACT 121 and proceeds to ACT 122. The processor 12a controls the lamp 12j to be turned on in green, as ACT 122. By this control, the lamp 12j switches from red lighting to green lighting. By changing an emission color of the lamp 12j from red to green, the store clerk can easily recognize that the customer performing settlement with the settlement device 12 corresponding to the lamp 12j stops using the eat-in corner. The processor 12a ends the external tax rate change process and returns to ACT 61 in FIG. 12.

Description will return to FIG. 13. When the quantity N is changed to the number n on the first confirmation screen SC3, the processor 12a determines YES in ACT 76 and proceeds to ACT 77. The processor 12a calculates a difference m obtained by subtracting the number n from the quantity N, as ACT 77. The processor 12a copies the commodity sales data 50a to the commodity registration area 41, as ACT 78. Hereinafter, the commodity sales data obtained by copying the commodity sales data 50a in ACT 78 is represented as commodity sales data 50b.

The processor 12a changes the quantity of the commodity sales data 50a before copying to the difference m and changes the quantity of the commodity sales data 50b after copying to the number n, as ACT 79. The processor 12a changes the price of the commodity sales data 50a before copying to an amount obtained by multiplying the unit price by the difference m, and changes the price of the commodity sales data 50b after copying to an amount obtained by multiplying the price by the number n, as an ACT 80.

Thereafter, the processor 12a acquires the commodity sales data 50b after copying from the commodity registration area 41, as ACT 81. Then, the processor 12a proceeds to ACT 91 in FIG. 14. That is, the processor 12a executes the processes of ACT 91 to ACT 122 described above with the commodity sales data 50b as a process target.

Thus, the processor 12a ends the external tax rate change process and returns to ACT 61 in FIG. 12. By returning to ACT 61, the processor 12a switches the screen of the touch panel 12f to the registration details list screen SC5 (see FIG. 23). Then, the processor 12a waits for a new commodity to be selected from the registration details list 60 on the registration details list screen SC5 or waits for the end button BT6 to be touched.

FIG. 23 is a display example of a registration details list screen SC5. The registration details list screen SC5 is displayed on the touch panel 12f after the “Yes” button BT9 is touched on the second confirmation screen SC4. The registration details list screen SC5 has the same configuration as that of the registration details list screen SC2. However, in the registration details list 60, a diamond mark “⋄” and a star mark “⋆” indicating a tax rate change, as the attributes, are added to the commodity D whose tax rate is changed. The tax mark 61 of the commodity D is “external 10” because the tax rate is changed to the normal tax rate of 10%. Furthermore, at this point in time, the amount of the first totalizer 44 is 1,500 yen, which is unchanged, but the amount of the external tax area 42 is 60 yen, and thus the total amount is 1,560 yen.

The customer who confirms the registration details list screen SC5 subsequently touches the row in which the commodity name “commodity E” is displayed. This operation corresponds to the operation 14 described above. When a new commodity is selected from the registration details list 60 in this way, the processor 12a executes the processes of ACT 64 to ACT 69 again. For the commodity E, the tax rate can be changed. The commodity E is an internal tax commodity. Accordingly, in the case of the operation 14, the processor 12a executes the internal tax rate change process. Here, the commodity sales data 50 selected in ACT 64, that is, the commodity sales data 50 of the commodity E is hereinafter represented as commodity sales data 50c.

FIGS. 16 to 18 are flowcharts illustrating a specific procedure of the internal tax rate change process. When entering the internal tax rate change process, the processor 12a displays a first confirmation screen SC6 (see FIG. 24) on the touch panel 12f, as ACT 131 in FIG. 16.

FIG. 24 is a display example of the first confirmation screen SC6. The first confirmation screen SC6 is displayed on the touch panel 12f after the operation 14. The first confirmation screen SC6 has the same configuration as that of the first confirmation screen SC3. Accordingly, in the first selected commodity area AR3, the commodity name “commodity E” and the tax type and the tax rate “internal tax 8%” or “tax included 8%” of the selected commodity are displayed. In the second selected commodity area AR4, the quantity “5 units”, the unit price “100 yen”, the tax-included amount “500 yen”, and the like of the selected commodity are displayed.

The customer eats and drinks only 2 items of the 5 items purchased for the commodity E at the eat-in corner. In this case, the customer touches the column 62. Then, images of the numerical buttons from the numerical value “1” to the numerical value “4” are displayed, and thus the customer touches the button image of the numerical value “2”, and then touches the “Yes” button BT7 to instruct execution of the tax amount recalculation. These operations correspond to the operation 15.

The processor 12a causing the first confirmation screen SC6 to be displayed confirms whether or not the continuation of the process is instructed, as ACT 132. When the “yes” button BT7 on the first confirmation screen SC6 is not touched, the processor 12a determines that the continuation of the process is not instructed. When the continuation of the process is not instructed, the processor 12a determines NO in ACT 132 and proceeds to ACT 133. The processor 12a confirms whether or not the stop of the process is instructed, as ACT 133. When the “No” button BT8 on the first confirmation screen SC6 is not touched, the processor 12a determines that the stop of the process is not instructed. When the stop of the process is not instructed, the processor 12a determines NO in ACT 133 and returns to ACT 132. Here, the processor 12a waits for an instruction to continue the process in ACT 132 or waits for an instruction to stop the process in ACT 133.

When the stop of the process is instructed, that is, when the “No” button BT8 on the first confirmation screen SC6 is touched, the processor 12a determines YES in ACT 133 and proceeds to ACT 134. The processor 12a erases the first confirmation screen SC6, as ACT 134. Then, the processor 12a ends the internal tax rate change process, and returns to ACT 61 in FIG. 12.

When the continuation of the process is instructed, that is, when the “Yes” button BT7 on the first confirmation screen SC6 is touched, the processor 12a determines YES in ACT 132 and proceeds to ACT 135. The processor 12a controls the lamp 12j to be turned on in red, as ACT 135. When the lamp 12j is already turned on in red, the processor 12a skips the process of ACT 135.

The processor 12a confirms whether or not the quantity N is changed to a smaller number n on the first confirmation screen SC6, as ACT 136. In the case of the operation 15, the quantity N is changed to the number n. The processor 12a determines YES in ACT 136 and proceeds to ACT 137. The processor 12a calculates a difference m obtained by subtracting the number n from the quantity N, as ACT 137. The processor 12a copies the commodity sales data 50c to the commodity registration area 41, as ACT 138. Hereinafter, the commodity sales data obtained by copying the commodity sales data 50c in ACT 138 will be represented as commodity sales data 50d.

The processor 12a changes the quantity of the commodity sales data 50c before copying to the difference m and changes the quantity of the commodity sales data 50d after copying to the number n, as ACT 139. The processor 12a changes the price of the commodity sales data 50c before copying to an amount obtained by multiplying the unit price by the difference m and changes the price of the commodity sales data 50c after copying to an amount obtained by multiplying the unit price by the number n, as ACT 140.

Thereafter, the processor 12a acquires the commodity sales data 50d after copying from the commodity registration area 41, as ACT 141. Then, the processor 12a proceeds to ACT 151 in FIG. 17.

When the quantity N is not changed on the first confirmation screen SC6, the processor 12a determines NO in ACT 136, skips the processes of ACT 137 to ACT 141, and proceeds to ACT 151 in FIG. 17.

The processor 12a subtracts the price of the commodity sales data 50x from the first totalizer 44 and the fifth totalizer 48, as ACT 151. The commodity sales data 50x becomes the commodity sales data 50c when the processes of ACT 137 to ACT 141 are skipped, and becomes the commodity sales data 50d when the processes are not skipped.

The processor 12a acquires a reduced tax rate of 8%, as ACT 152. Then, the processor 12a calculates a base price S obtained by subtracting the internal tax amount from the unit price R of the commodity sales data 50x by the following expression (5), as ACT 153.

S=R/(1+0.08) (5)

The processor 12a acquires the normal tax rate of 10%, as ACT 154. Then, the processor 12a calculates a tax-included price T with the normal tax rate of 10% by the following expression (6), as ACT 155.

T=S+S*0.1 (6)

The processor 12a adds the tax-included price T to the first totalizer 44 and fourth totalizer 47, respectively, as ACT 156.

The processor 12a changes the price of the commodity sales data 50x to the tax-included price T and changes the tax rate thereof to the normal tax rate of 10%, as ACT 157. The processor 12a changes the tax display status of the commodity sales data 50x to “4”, as ACT 158. Furthermore, the processor 12a sets the change flag of the commodity sales data 50x to “1”, as “ACT 159”.

Thereafter, the processor 12a performs the same processes as the processes of ACT 37 to ACT 39 described above, as ACT 160 to ACT 162. That is, the processor 12a calculates the normal internal tax amount Q4 by the expression (3), as ACT 160. The processor 12a calculates the reduced internal tax amount Q5 by the expression (4), as ACT 161. Then, the processor 12a updates the internal tax amount Q6 of the internal tax amount area 43 to the sum of the normal internal tax amount Q4 and the reduced internal tax amount Q5, as ACT 162.

When the processes of ACT 160 to ACT 162 are completed, the processor 12a causes a second confirmation screen SC7 (see FIG. 25) to be displayed on the touch panel 12f, as ACT 163.

FIG. 25 is a display example of the second confirmation screen SC7. The second confirmation screen SC7, which is displayed on the touch panel 12f after the “Yes” button BT7 is touched on the first confirmation screen SC6, has the same configuration as that of the second confirmation screen SC4. Accordingly, in the third selected commodity area AR5, the commodity name “commodity E” of the commodity whose tax rate is changed and the tax type and the tax rate “internal tax 8% internal tax 10%” before and after the change are displayed. In the fourth selected commodity area AR6, the quantity “2 units”, the unit price “102 yen”, the tax-included amount “204 yen”, and the like of the commodity E whose tax rate is changed are displayed.

The customer who confirms the second confirmation screen SC7 touches the “Yes” button BT9 when executing the change of the tax rate. The customer touches the “No” button BT10 when stopping the change of the tax rate.

The processor 12a causing the second confirmation screen SC7 to be displayed confirms whether or not the execution of the tax rate change is instructed, as ACT 164. When the “yes” button BT9 on the second confirmation screen SC7 is not touched, the processor 12a determines that the execution of the tax rate change is not instructed. When the execution of the tax rate change is not instructed, the processor 12a determines NO in ACT 164 and proceeds to ACT 165. The processor 12a confirms whether or not the stop of the tax rate change is instructed, as ACT 165.

When the “No” button BT10 on the second confirmation screen SC7 is not touched, the processor 12a determines that the stop of the process is not instructed. When the stop of the process is not instructed, the processor 12a determines NO in ACT 165 and returns to ACT 164. Here, the processor 12a waits for an instruction to execute the tax rate change in ACT 164 or waits for an instruction to stop the tax rate change in ACT 165.

When the execution of the tax rate change is instructed, that is, when the “Yes” button BT9 on the second confirmation screen SC7 is touched, the processor 12a determines YES in ACT 164 and proceeds to ACT 166. The processor 12a erases the second confirmation screen SC7, as ACT 166. Then, the processor 12a ends the internal tax rate change process and returns to ACT 61 in FIG. 12.

When the stop of the tax rate change is instructed, that is, when the “No” button BT10 on the second confirmation screen SC7 is touched, the processor 12a determines YES in ACT 165 and proceeds to ACT 167. The processor 12a acquires stop data, as ACT 167. The stop data is the commodity sales data 50x targeted for the processes of ACT 151 to ACT 162.

When the commodity sales data 50x which is the stop data is acquired, the processor 12a proceeds to ACT 171 in FIG. 18. The processor 12a subtracts the price of the commodity sales data 50x from the first totalizer 44 and the fourth totalizer 47, as ACT 171. The processor 12a acquires the normal tax rate of 10%, as ACT 172. Then, the processor 12a calculates the base price S obtained by subtracting the internal tax amount from the unit price R of the commodity sales data 50x by the expression (5) described above, as ACT 173.

The processor 12a acquires the reduced tax rate of 8%, as ACT 174. Then, the processor 12a calculates a tax-included price U with the reduced tax rate of 8% by the following expression (7), as ACT 175.

U=S+S*0.08 (7)

The processor 12a adds the tax-included price U to the first totalizer 44 and the fifth totalizer 48, respectively, as ACT 176.

The processor 12a changes the price of the commodity sales data 50x to the tax-included price U and changes the tax rate thereof to the reduced tax rate of 8%, as ACT 177. The processor 12a changes the tax display status of the commodity sales data 50x to “5”, as ACT 178. Furthermore, the processor 12a resets the change flag of the commodity sales data 50x to “0”, as ACT 179.

Thereafter, the processor 12a performs the same processes as the processes of ACT 37 to ACT 39 described above, as ACT 180 to ACT 182. That is, the processor 12a calculates the normal internal tax amount Q4 by the expression (3), as ACT 180. The processor 12a calculates the reduced internal tax amount Q5 by the expression (4), as ACT 181. Then, the processor 12a updates the internal tax amount Q6 of the internal tax amount area 43 to the sum of the normal internal tax amount Q4 and the reduced internal tax amount Q5, as ACT 182.

By executing the processes of ACT 171 to ACT 182 by the processor 12a, data of the commodity registration area 41, the external tax amount area 42, the internal tax amount area 43, the first totalizer 44, the second totalizer 45, the third totalizer 46, the fourth totalizer 47, and the fifth totalizer 48 is returned to the state before executing the process of ACT 151.

When the process of ACT 182 is completed, the processor 12a erases the second confirmation screen SC7, as ACT 183. Then, the processor 12a confirms whether or not there is the commodity sales data 50 for which the change flag is set to “1” among all the commodity sales data 50 registered in the commodity registration area 41, as ACT 184. When there is even one commodity sales data 50 for which the change flag is set to “1”, the processor 12a determines NO in ACT 184. The processor 12a ends the internal tax rate change process and returns to ACT 61 in FIG. 12.

When there is no commodity sales data 50 for which the change flag is set to “1” in the commodity registration area 41, the processor 12a determines YES in ACT 184 and proceeds to ACT 185. The processor 12a controls the lamp 12j to be turned on in green, as ACT 185. By this control, the lamp 12j switches from red lighting to green lighting. The processor 12a ends the internal tax rate change process and returns to ACT 61 in FIG. 12. By returning to ACT 61, the processor 12a switches the screen of the touch panel 12f to the registration details list screen SC8 (see FIG. 26). Then, the processor 12a waits for a new commodity to be selected from the registration details list 60 on the registration details list screen SC8 or waits for the end button BT6 to be touched.

FIG. 26 is a display example of a registration details list screen SC8. The registration details list screen SC8 is displayed on the touch panel 12f after the “Yes” button BT9 is touched on the second confirmation screen SC7. The registration details list screen SC8 has the same configuration as that of the registration details list screens SC2 and SC5. However, in the registration details list 60, the commodity name “commodity E”, the quantity “2”, the unit price “102”, the amount “204”, and the tax mark 61 of the commodity E in which the tax rate of two units is changed are added to the sixth row. The tax mark 61 is “internal 10” because the tax rate is changed to the normal tax rate of 10%. As the attributes, a star mark “⋆” indicating a tax rate change is added together with a diamond mark “⋄” indicating a reduced tax rate commodity. On the other hand, as for the data of the commodity E in the fifth row, the quantity is changed from “5” to “3”. Furthermore, the amount of the external tax amount area 42 is 60 yen, which is unchanged, but the amount of the first totalizer 44 is 1,504 yen, and thus the total amount is 1,564 yen.

Here, the computer having the processor 12a as a main body constitutes a tax amount changing unit by executing the processes of ACT 68 and ACT 69 of FIG. 12, that is, the processes described with reference to FIGS. 13 to 18. That is, the computer changes the amount of the tax imposed on the commodity for which selection is received by the receiving unit from the first tax amount calculated at the first tax rate before the change to the second tax amount calculated at the second tax rate after the change. Incidentally, when the first tax rate before the change is the reduced tax rate of 8%, the second tax rate after the change is the normal tax rate of 10%. When the first tax rate before the change is the normal tax rate of 10%, the second tax rate after the change is the reduced tax rate of 8%.

Description will return to FIG. 12. When the end button BT6 is touched in the waiting state of ACT 62 and ACT 63, the processor 12a determines YES in ACT 63 and proceeds to ACT 44 of FIG. 11. That is, the processor 12a recalculates the total amount and causes the payment method selection screen SC1 including the total amount to be displayed on the touch panel 12f Then, the processor 12a enters into the waiting state of ACT 46 or ACT 47.

Here, when the customer touches the button image BT1, BT2, or BT3 of any of the payment methods, the processor 12a determines YES in ACT 46 and proceeds to ACT 49. The processor 12a performs the settlement process, as ACT 49. For example, when the touched button is the cash button BT1, the processor 12a executes a settlement process by cash payment for the total amount calculated in the process of ACT 4. When the touched button is the credit button BT2, the processor 12a executes a settlement process by credit card payment for the total amount. When the touched button is the electronic money button BT3, the processor 12a executes a settlement process by electronic money payment for the total amount. Since these settlement processes are well-known existing processes, the description thereof is omitted here.

When the selection of the commodity whose tax rate is to be changed is not received, the total amount calculated in the process of ACT 4 is the total amount of sales commodities including the first tax amount calculated at the first tax rate before the change. When the selection of a commodity whose tax rate is to be changed is received by the receiving unit, the total amount calculated in the process of ACT 4 is the total amount of the sales commodities including the second tax amount calculated at the second tax rate after the change.

Here, the computer having the processor 12a as a main body constitutes a settlement unit by executing the process of ACT 49. That is, when the selection of the commodity whose tax rate is to be changed is received by the receiving unit, the computer settles one transaction based on the total amount of the sales commodities including the second tax amount. Incidentally, when the selection of the commodity whose tax rate is to be changed is not received, the computer settles one transaction based on the total amount of the sales commodities including the first tax amount.

When the settlement process is completed, the processor 12a controls the issuance of a receipt, as ACT 50. That is, the processor 12a generates receipt data based on the data stored in the commodity registration area 41, the external tax area 42, the internal tax area 43, the first totalizer 44, the second totalizer 45, the third totalizer 46, the fourth totalizer 47, the fifth totalizer 48, and the payment data area 49 and outputs the receipt data to the printer 12g. By this control, the printer 12g operates to print the receipt data on paper. When printing is completed, the paper is cut and issued as a receipt 70 (see FIG. 27).

FIG. 27 illustrates an example of the receipt 70 issued after performing the operation 6 and the operation 7, both of which are performed after completion of the operation 15. In the receipt 70, the subtotal amount, the amount subject to an external tax with the normal tax rate, the amount subject to an external tax with the reduced tax rate, the external tax amount, the total amount, and the internal tax amount included in the total amount are written together with the tax type, the commodity name, the unit price, the quantity, and the price of the commodity registered as one transaction. The subtotal amount is the amount of the first totalizer 44. The amount subject to the external tax with the normal tax rate is the amount of the second totalizer 45. The amount subject to the external tax with the reduced tax rate is the amount of the third totalizer unit 46. The external tax amount is the amount of the external tax amount area 42. The total amount is a sum of the amount of the first totalizer 44 and the amount of the external tax amount area 42. The internal tax amount is the amount of the internal tax amount area 43. A unique transaction code (transaction No.) is also printed on the receipt 70.

The processor 12a generates transaction data, as ACT 51. The transaction data includes sales data of commodities sold as one transaction and payment data of the price for the transaction. The transaction data is generated based on each data stored in the commodity registration area 41, the external tax area 42, the internal tax area 43, the first totalizer 44, the second totalizer 45, the third totalizer 46, the fourth totalizer 47, the fifth totalizer 48, and the payment data area 49.

The processor 12a controls the communication unit 12d to transmit the transaction data to the server 13, as ACT 52. By this control, the transaction data is transmitted from the communication unit 12d to the server 13 via the network 14.

The processor 12a controls the lamp 12j to be turned off, as ACT 53. By this control, the lamp 12j that is colored green or red is turned off. When the store clerk confirms that the lamp is turned off from green, a customer who performed the settlement with the settlement device 12 corresponding to the lamp can be recognized as a customer who does not use the eat-in corner. When the store clerk confirms that the lamp is turned off from red, a customer who performed the settlement with the settlement device 12 corresponding to the lamp can be recognized as a customer who uses the eat-in corner. Thus, the processor 12a ends the information processing according to the settlement program.

As such, in the commodity sales data processing system 10 of this embodiment, it is possible to change the tax rate in order for foods registered as take-out in the registration device 11 to be set as in-store eating and drinking at the settlement stage of the settlement device 12. Moreover, this operation is simple and even a customer can easily perform this operation. Accordingly, even in the semi-self-service type commodity sales data processing system 10 in which the registration device 11 is operated by a store clerk, and the settlement device 12 is operated by a customer, the system 10 is advantageously capable of coping with the tax rate change by a simple operation when the tax rate of a tax imposed on the commodity changes depending on the form of consumption. When the store clerk registers the commodity subject to the reduced tax rate with the registration device 11, there is no need to confirm with the customer whether the foods are for take-out or in-store eating and drinking. Accordingly, the effect of reducing the burden on the store clerk can also be achieved.

In this embodiment, regardless of if the commodity subject to the reduced tax rate system is an external tax commodity or an internal tax commodity, a customer who is an operator can change the tax rate without being aware of the tax type of the commodity. Accordingly, the customer can easily handle the tax rate change.

In addition, it is possible to easily handle a case where the tax rate is changed for only some commodities. Thus, it is possible to provide the settlement device 12 that can handle the tax rate change by a simple operation even when the tax rate of a tax imposed on the commodity changes depending on the form of consumption, and the commodity sales data processing system 10 including the settlement device 12.

Thus, although the embodiment describes (a) the settlement device that can handle the tax rate change by a simple operation even when the tax rate of the tax imposed on the commodity changes depending on the form of consumption and (b) the commodity sales data processing system including this settlement device, the embodiment is not limited thereto.

For example, although the eat-in button BT5 is provided in the settlement device 12 in the above-described embodiment, a button having the same function as the eat-in button BT5 may be additionally provided in the registration device 11. Accordingly, for example, when the store is not congested, the tax rate of the commodity subject to the reduced tax rate can be changed in the registration device 11. Incidentally, when a change in the tax rate of a commodity is set in the registration device 11, for the commodity, the fact that the tax rate change is already set may be displayed in the attribute column of the registration details list screen SC2 displayed on the touch panel 12f when the eat-in button BT5 is input in the settlement device 12.

For example, the above-described embodiment describes the case where the commodity record 15R is generated on the assumption of take-out for beverages or foods that are the reduced tax rate commodities, as an example. In this regard, the commodity record 15R may be generated on the assumption of in-store eating and drinking for beverages or foods that are the reduced tax rate commodities. In that case, an in-store eating and drinking button is provided instead of the eat-in button BT5. Then, when the in-store eating and drinking button is input, a process of changing the tax rate from the normal tax rate to the reduced tax rate is executed. In this regard, as described above, the in-store eating and drinking button may be provided in the registration device 11. Even in this case, if the in-store eating and drinking button is operated in the registration device 11, for the commodity, the fact that the tax rate change is already set may be displayed in the attribute column of the registration details list screen SC2 displayed on the touch panel 12f of the settlement device 12. In the embodiment described above, the normal tax rate is set to 10% and the reduced tax rate is set to 8%, but the value of the tax rate is merely an example.

Two buttons of the eat-in button BT5 and the in-store eating and drinking button may be provided in the registration device 11 and the settlement device 12, respectively. Alternatively, instead of the eat-in button BT5 and the in-store eating and drinking button, one button as a tax rate change button may be provided on the settlement device 12 or both the registration device 11 and the settlement device 12. Incidentally, the tax rate change button is provided instead of the eat-in button BT5 (see FIG. 19) in the settlement device 12. Then, when this tax rate change button is pressed, the registration details list screen SC2 illustrated in FIG. 20 is displayed in the settlement device 12. In this case, the message MS3 on the registration details list screen SC2 is, for example, “Please select a commodity whose tax rate is to be changed.” or “Please select a commodity to be eat-in/take-out”. Here, when the customer selects a commodity from the registration details list 60 similarly as in the embodiment described above, the tax rate of the commodity is changed. Specifically, the processor 12a refers to the tax rate set for the selected commodity and changes the tax rate to a different tax rate. For example, when the normal tax rate of 10% is set, the processor 12a executes the processes of ACT 111 to ACT 119 in FIG. 15 or the processes of ACT 171 to ACT 182 in FIG. 18 so as to change the normal tax rate of 10% to the reduced tax rate of 8%. For example, when the reduced tax rate of 8% is set, the processor 12a executes the processes of ACT 91 to ACT 99 in FIG. 14 or the processes of ACT 151 to ACT 162 in FIG. 17 so as to change the reduced tax rate of 8% to the normal tax rate of 10%. Even if such a configuration is adopted, the same effects as that of the embodiment described above can be achieved.

In the embodiment described above, the commodity name, the quantity, the tax mark 61, and the like of the commodity sales data 50 registered in the commodity registration area 41 are displayed in the registration details list 60 on the registration details list screen SC2 in the registration sequence. As an attribute, a diamond mark “⋄” is added to the commodities subject to the reduced tax rate system. In this regard, the commodities for which the commodity name, the quantity, the tax mark 61, and the like are displayed in the registration details list 60 may be limited to the commodities for which the tax rate can be changed. Thus, there is an advantage that the customer can easily select a commodity whose tax rate is to be changed.

The embodiment describes the case where the registration device 11 transmits the checkout data to the server 13 and the registration device 11 or the server 13 transmits the transaction code to the settlement device, as an example. Such a mechanism of the semi-self-service type method is not particularly limited. For example, the registration device 11 prints and outputs a transaction code on a paper medium, and the settlement device 12 acquires the checkout data transmitted from the registration device 11 by reading the printed transaction code with a scanner of the settlement device 12.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A settlement device that is connected to a registration device via a network and that performs settlement for a plurality of commodities registered by the registration device, the settlement device comprising:
a computer configured to:
acquire commodity data related to the plurality of commodities registered by the registration device;
receive a selection of a first commodity from among the plurality of commodities;
in response to receiving the selection of the first commodity, change a tax amount of a tax imposed on the first commodity from a first tax amount calculated at a first tax rate before the change to a second tax amount calculated at a second tax rate after the change; and
settle a transaction based on a total cost of the first commodity, the total cost of the first commodity including the second tax amount.

2. The settlement device of claim 1, wherein the commodity data includes a price of the first commodity and the first tax rate of the tax imposed on the first commodity; and
wherein the computer is configured to calculate the first tax amount based on the price and the first tax rate, and wherein the computer is configured to calculate the second tax amount based on the price and the second tax rate.

3. The settlement device of claim 2, wherein the commodity data further includes tax type information for identifying whether the price of the first commodity is a tax-included price including the tax amount or a tax-excluded price not including the tax amount; and
wherein, in response to the tax type information indicating that the price of the first commodity is the tax-included price, the computer is configured to change the price of the first commodity from a tax-included price including the first tax amount to a tax-included price including the second tax amount.

4. The settlement device of claim 1, wherein the plurality of commodities include at least one commodity of a first type and at least one commodity of a second type, wherein the first commodity is one of the commodities of the first type, and wherein the selection of the first commodity includes a selection of the first type of commodity and an input of a number of commodities of the first type whose tax rate is to be changed.

5. The settlement device of claim 4, wherein the commodities of the first type further include a second commodity, and wherein the computer is configured to settle the transaction based on the total cost of the first commodity and a total cost of a second commodity, wherein the total cost of the second commodity includes a third tax amount calculated at the first tax rate.

6. The settlement device of claim 1, wherein the computer is configured to settle the transaction based on the total cost of the first commodity and a total cost of a second commodity, wherein the total cost of the second commodity includes a third tax amount calculated at the first tax rate.

7. The settlement device of claim 6, wherein the computer is configured to settle the transaction based on the total cost of the first commodity, the total cost of the second commodity, and the total cost of a third commodity, wherein the total cost of the third commodity does not include a tax amount.

8. The settlement device of claim 1, further comprising an indicator operatively coupled to the computer, wherein the computer is configured to receive a transaction code associated with the transaction from the registration device, and wherein the computer is configured to control the indicator to provide a first indication in response to receiving the transaction code.

9. The settlement device of claim 8, wherein the computer is configured to control the indicator to provide a second indication in response to receiving the selection of the first commodity.

10. The settlement device of claim 9, wherein the indicator is a visual indicator, wherein the first indication is light of a first color, and wherein the second indication is light of a second color different from the first color.

11. The settlement device of claim 1, wherein the first commodity includes at least one of a food or a beverage, wherein the first tax rate is associated with one of (a) consumption of the first commodity within a store associated with the settlement device or (b) consumption of the first commodity outside the store, and wherein the second tax rate is associated with the other of (a) consumption of the first commodity within the store or (b) consumption of the first commodity outside the store.

12. A commodity sales data processing system comprising:
a processor configured to generate checkout data related to a plurality of commodities registered by the processor; and
the settlement device of claim 1.

13. A method of settlement to be performed by a computer of a settlement device, the method comprising:
acquiring commodity data related to a plurality of commodities registered by a registration device;
receiving a selection of a selected commodity from the plurality of commodities, the selection indicating that a tax rate of the selected commodity is to be changed;
changing a tax amount of a tax imposed on the selected commodity from a first tax amount calculated at a first tax rate before the change to a second tax amount calculated at a second tax rate after the change; and
settling a transaction based on a total cost of the selected commodity, the total cost including the second tax amount.

14. The method of claim 13, wherein the commodity data further includes a price of the selected commodity and tax type information for identifying whether the price of the selected commodity is a tax-included price including the tax amount or a tax-excluded price not including the tax amount, the method further comprising:
in response to the tax type information indicating that the price of the selected commodity is the tax-included price, changing the price of the selected commodity from a tax-included price including the first tax amount to a tax-included price including the second tax amount.

15. A method of settlement, comprising:
identifying, by a registration device, a first commodity to be purchased;
providing, by the registration device, first commodity data associated with the first commodity to a settlement device, the first commodity data including a price of the first commodity and a first tax rate of the first commodity;
in response to receiving a request indicating that a tax rate of the first commodity should be changed, calculating, by the settlement device, a total cost of the first commodity based on the price of the first commodity and a second tax rate of the first commodity;
if the request indicating that the tax rate of the first commodity should be changed is not received, calculating, by the settlement device, the total cost of the first commodity based on the price of the first commodity and the first tax rate; and
settling, by the settlement device, a transaction based on the total cost of the first commodity.

16. The method of claim 15, further comprising:
providing, by the registration device, a transaction code associated with the transaction to the settlement device; and
in response to receiving the transaction code, providing, by an emitter of the settlement device, light of a first color.

17. The method of claim 16, further comprising
in response to receiving the request indicating that the tax rate of the first commodity should be changed, providing, by the emitter of the settlement device, light of a second color different from the first color.

18. The method of claim 15, wherein the first commodity data further includes tax type information for identifying whether the price of the first commodity is a tax-included price including a tax amount or a tax-excluded price not including the tax amount, the method further comprising:
in response to both (a) receiving the request indicating that the tax rate of the first commodity should be changed and (b) the tax type information indicating that the price of the first commodity is the tax-included price, changing, by the settlement device, the price of the first commodity based on the first tax rate and the second tax rate.

19. The method of claim 15, further comprising generating, by the settlement device, a receipt displaying the first tax rate, the second tax rate, and the total cost of the first commodity.

20. The method of claim 15, further comprising:
identifying, by the registration device, a second commodity to be purchased;
providing, by the registration device, second commodity data associated with the second commodity to the settlement device, the second commodity data including a price of the second commodity, a tax rate of the second commodity, and an indication that the tax rate of the second commodity cannot be changed;
calculating, by the settlement device, a total cost of the second commodity based on the price of the second commodity and the tax rate of the second commodity,
wherein the transaction is settled based on the total cost of the first commodity and the total cost of the second commodity.
